(19) United States
(12) Patent Application Publication
(10) Pub. No.: US 2026/0161803 A1
(43) Pub. Date: Jun. 11, 2026

(54) SYSTEM AND METHOD FOR SYNTHESIS OF FAILURE SCENARIOS IN AN INDUSTRIAL SYSTEM USING REINFORCEMENT LEARNING

(71) Applicant: THE GOVERNING COUNCIL OF THE UNIVERSITY OF TORONTO, Toronto (CA)

(72) Inventors: Amr Mohamed Saber MOHAMED, Kingston (CA); Deepa Kundur, Oakville (CA)

(21) Appl. No.: 19/410,108

(22) Filed: Dec. 5, 2025

Related U.S. Application Data
(60) Provisional application No. 63/728,204, filed on Dec. 5, 2024.

(51) Int. Cl. G06F 21/57; G06N 3/0455; G06N 3/092

(52) U.S. Cl. CPC G06F 21/577; G06N 3/0455; G06N 3/092; G06F 2221/034

(57) ABSTRACT

A system and method for determining actions that disrupt or compromise an industrial system for determination of vulnerabilities in the industrial system. The method includes: iteratively training one or more reinforcement learning agents to each determine a learned policy that outputs one or more actions that disrupt or compromise the operation of the industrial system when applied to a dynamical model, the dynamical model outputs a representation of the response of the industrial system to such actions, training comprises learning the learned policy based on observing an operational state of the industrial system while sequences of the actions are injected into the dynamical model to determine the actions that force the industrial system into an unfavorable mode of operation or breach the safety of the industrial system by forcing its operational state outside a safe set of operation.

### TECHNICAL FIELD

The following relates generally to protection of industrial systems; and more specifically, to a system and method for synthesis of failure scenarios in an industrial system using reinforcement learning.

### BACKGROUND

Industrial systems are evolving to provide enhanced accessibility, availability, efficiency, and reliability through an increased use of advanced information, computation, and communication technologies. This modernization can, however, introduce complex operation with complex unapparent failure scenarios or complex vulnerabilities that enable cyberattacks. The resulting damage of such failure scenarios in industrial systems can have devastating consequences to the welfare of society, including economic loss, injury, or even loss of life.

In the case of cyber threats, cyberattacks on industrial systems are increasingly exhibiting prior system knowledge on the part of the attacker, stealth, and a high degree of resources and sophistication. Without a reasonable understanding of attacker resources and strategies, cyber defense is generally limited to taking a reactive stance; leaving the defence at a fundamental disadvantage and subject to be more easily bypassed.

### SUMMARY

In an aspect, there is provided a method for determining actions that disrupt or compromise an industrial system for determination of vulnerabilities in the industrial system, the method executed on one or more processors, the method comprising: receiving a dynamical model of operation of the industrial system; iteratively training one or more reinforcement learning agents to each determine a learned policy that outputs one or more actions that disrupt or compromise the operation of the industrial system when applied to the dynamical model, the dynamical model takes as input the actions and outputs a representation of the response of the industrial system to such actions, training of each of the one or more reinforcement learning agents comprises learning the learned policy based on observing an operational state of the industrial system while sequences of the actions are injected into the dynamical model to determine the actions that force the industrial system into an unfavorable mode of operation or breach the safety of the industrial system by forcing its operational state outside a safe set of operation; and outputting the one or more trained reinforcement learning agents or the one or more learned policies, or both, for determination of actions that disrupt or compromise the industrial system.

In a particular case of the method, the method further comprising synthesizing failure scenarios of the industrial system using the one or more actions that disrupt or compromise the operation of the industrial system determined by the trained reinforcement learning agents, and outputting the synthesized failure scenarios of the industrial system.

In another case of the method, the dynamical model comprises simulation testbeds, digital twins, or state-space dynamical models, and wherein one or more inputs to the industrial system permit the one or more reinforcement learning agents to inject disturbances that compromise or disrupt the operation of the industrial system.

In yet another case of the method, the industrial system comprises a power system, wherein the dynamical model comprises a model of operation of the power system, wherein the one or more actions that disrupt or compromise the operational aspect of the industrial system comprise disturbances that compromise the power system control.

In yet another case of the method, the actions comprise changes in dynamics of the industrial system to place the industrial system in an undesirable or unsafe operation.

In yet another case of the method, training of the one or more reinforcement learning agents comprises using deep deterministic policy gradient reinforcement learning to simulate switching an entire load on or off.

In yet another case of the method, the one or more reinforcement learning agents are initialized without knowledge of the physical dynamics or characteristics of the industrial system.

In yet another case of the method, the iterations continue until a policy includes actions that provide the most detriment to the industrial system is reached.

In yet another case of the method, during each iteration of training, each reinforcement learning agent executes a sequence of the actions on the industrial system over a training episode, and wherein the actions are evaluated based on the extent to which the industrial system is driven into the unfavorable mode of operation.

In yet another case of the method, the method further comprising using the learned policy to train a supervised machine learning model to categorize patterns of attack in the operational data of the industrial system, the supervised machine learning model taking operational data measurements of the industrial system as input.

In another aspect, there is provided a system for determining actions that disrupt or compromise to the industrial system for determination of vulnerabilities in the industrial system, the system comprising one or more processors and a data storage, the data storage comprising instructions for the one or more processors to execute: a data module to receive a dynamical model of operation of the industrial system; and a machine learning module to: train one or more reinforcement learning agents to each determine a learned policy that outputs one or more actions that disrupt or compromise the operation of the industrial system when applied to the dynamical model, the dynamical model takes as input the actions and outputs a representation of the response of the industrial system to such actions, training of each of the one or more reinforcement learning agents comprises learning the learned policy based on observing an operational state of the industrial system while sequences of the actions are injected into the dynamical model to determine the actions that force the industrial system into an unfavorable mode of operation or breach the safety of the industrial system by forcing its operational state outside a safe set of operation; and output the one or more trained reinforcement learning agents or the learned policies, or both, for determination of actions that disrupt or compromise the industrial system

In a particular case of the system, the machine learning module further synthesizes failure scenarios of the industrial system using the one or more actions that disrupt or compromise the operation of the industrial system determined by the trained reinforcement learning agents, and outputs the synthesized failure scenarios of the industrial system.

In another case of the system, the industrial system comprises a power system, wherein the dynamical model comprises a model of operation of the power system, wherein the one or more actions that disrupt or compromise the operational aspect of the industrial system comprise disturbances that compromise the power system control.

In yet another case of the system, the actions comprise changes in dynamics of the industrial system to place the industrial system in an undesirable or unsafe operation.

In yet another case of the system, during each iteration of training, each reinforcement learning agent executes a sequence of the actions on the industrial system over a training episode, and wherein the actions are evaluated based on the extent to which the industrial system is driven into the unfavorable mode of operation.

In yet another case of the system, the machine learning module further uses the learned policy to train a supervised machine learning model to categorize patterns of attack in the operational data of the industrial system, the supervised machine learning model taking operational data measurements of the industrial system as input.

In another aspect, there is provided a method for detecting anomalies in an industrial system, the method executed on one or more processors, the method comprising: receiving a training dataset, the training dataset comprising control signal and frequency data from a plurality of simulations on the industrial system; training an autoencoder using the training dataset, the autoencoder comprising a neural network machine learning model, the autoencoder expressed as a mapping between the input data and a reconstruction of the input data, the training of the autoencoder comprising minimizing a mean square error between training data in the training dataset and reconstructions of such training data; determining a threshold, using the autoencoder, to differentiate between normal and anomalous data based on a maximum reconstruction error; and outputting the threshold for detection of anomalies in the industrial system.

In a particular case of the method, the method further comprising: receiving control signal and frequency input data for the industrial system; determining, using the trained autoencoder, whether reconstruction error for the input data is below the threshold; labelling the input data as normal where the reconstruction error is below the threshold, and otherwise, labelling the input data as anomalous; and outputting the labelling.

In another case of the method, the method further comprising preparing the training dataset by performing a simulation of normal industrial system operation and randomly cropping portions of the training dataset.

In another case of the method, the portions are sampled at regular intervals and have variable time lengths.

These and other aspects are contemplated and described herein. It will be appreciated that the foregoing summary sets out representative aspects of embodiments to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 illustrates a conceptual diagram of a system for failure scenario synthesis on industrial systems using reinforcement learning, in accordance with an embodiment;

FIG. 2 is a flowchart for a method for failure scenarios synthesis on industrial systems using reinforcement learning, in accordance with an embodiment;

FIG. 3 illustrates charts showing change in load power as simulated by a random process and the resulting frequency and rate of change of frequency deviation;

FIG. 4 illustrates a conceptual diagram of a microgrid testbed;

FIG. 5 illustrates a reinforcement learning (RL) reward function, where an RL agent is rewarded for increasing a rate of change of frequency of the power system while maintaining small frequency deviation;

FIG. 6 illustrates charts showing time-domain simulations of two vulnerable microgrid testbeds, each with a different eigenmode frequency, demonstrating the ability of the RL agent of the system of FIG. 1 to attack different power systems;

FIG. 7 illustrates a chart showing a load switching attack reward function;

FIG. 8 illustrates charts showing results of a detailed model simulation for a load switching attack;

FIG. 9 is a chart illustrating reinforcement learning (RL) agent episode rewards and average rewards over 20 episodes for supervised attack detection;

FIG. 10 illustrates charts showing different false data injection (FDI) attacks;

FIG. 11 illustrates charts showing different aggregate load switching attacks;

FIG. 12 is a diagram showing a supervised attack detector confusion matrix;

FIG. 13 illustrates charts showing reconstruction of a trained autoencoder for unsupervised anomaly detection;

FIG. 14 is a chart showing root mean square (reconstruction) error of an unsupervised autoencoder-based anomaly detector during training;

FIG. 15 is a flowchart chart showing a method of combining autoencoder-based anomaly detection and supervised attack detection trained on RL-generated attack datasets to predict and detect cyberattacks in an industrial system;

FIG. 16 is an abstract visualization of grid events;

FIG. 17 is an abstract visualization of a high-dimensional function mapping grid events to their severity;

FIG. 18 is an abstract visualization illustrating sampled events within each zone, categorizing them as high-, medium-, or low-severity events;

FIG. 19 is a diagram showing an exemplary block diagram for a general area of a load frequency control model;

FIG. 20 is a diagram illustrating an RL agent, composed of actor and critic neural networks, interacting with an environment that emulates a power system;

FIG. 21 is a diagram showing categorizations of risk;

FIG. 22 is a chart showing an RL agent reward function;

FIG. 23 is a chart showing agent reward in each episode and rewards averaged over 25 episodes;

FIG. 24 illustrates charts showing load change, resulting frequency fluctuation, and rate of change of frequency;

FIG. 25 illustrates charts showing a representation of an optimal attack;

FIG. 26 is a zero-pole map showing where an optimization model generated attack yields precise attacks;

FIG. 27 illustrates charts showing an optimal attack on a modified system

FIG. 28 illustrates charts showing effectiveness of an RL-generated attack;

FIGS. 29A and 29B are charts showing reduced representations of sequences generated by an optimization model and an RL agent, respectively;

FIG. 30 is a t-SNE plot of all optimization model-generated and RL-generated data-points;

FIG. 31 is a chart showing training loss curves of classifiers;

FIG. 32A is a confusion matrix illustrating performances of a first classifier referred to as Classifier-1;

FIG. 32B is a confusion matrix illustrating performances of a second classifier referred to as Classifier-2;

FIG. 32C is a confusion matrix illustrating performances of a combination classifier;

FIG. 33 illustrates charts showing system frequencies during an RL-generated attack;

FIG. 34 illustrates charts showing frequency during sudden, relatively large load changes; and

FIG. 35 is a flowchart for a method for attack synthesis on power systems by detecting anomalies using an autoencoder, in accordance with an embodiment.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The present disclosure provides embodiments for synthesis of failure scenarios in an industrial system using reinforcement learning for use in determining vulnerabilities in the industrial system. In a non-limiting example, the below is generally directed to describing failure scenarios of an electrical power system. However, it should be understood that the present embodiments can be applied to any suitable dynamical industrial system, such as electric grids, healthcare systems, manufacturing plants, autonomous vehicles, supply chain management systems, and the like.

To detect common forms of data corruption attacks, industrial systems have traditionally relied on bad data detection (BDD) approaches, which were originally developed to detect highly corrupt measurements (often stemming from telemetry error). BDD methods use historical data sets, statistical approaches, and approximate system models to flag abnormal measurements, and thus, are limited to detecting simple failure scenarios, including naively constructed cyberattacks. Specifically, these approaches fail to detect attacks that either exploit model inaccuracy or are intentionally crafted such that their distribution is similar to that of the historical system data. To address these limitations, recent research on attack detection has leveraged data-driven approaches, such as machine learning (ML) and deep learning (DL). These approaches are generally more effective than traditional BDD, especially in detecting false data injection (FDI) in the context of state estimation and load frequency control (LFC) in power systems.

Nevertheless, ML and DL data-driven methods are typically evaluated using attacks that are randomly generated or crafted using a simple library of templates; which, importantly, can fail to perform against more realistic attacks that are complex in nature and targeted based on knowledge of system vulnerabilities and dynamics. Thus, the effectiveness of learning-based methods against such attacks is largely untested. In contrast, embodiments of the present disclosure advantageously provide a proactive stance to identify and address vulnerabilities.

Embodiments of the present disclosure provide synthesis of novel attacks through modelling of an intelligent attacker, to inform defense development pre-emptively. Attack synthesis provides insight into attacker strategies to, at least, forecast security requirements, appropriately reinforce grid defenses, and/or improve situational awareness. In some examples, attack synthesis can use generative adversarial networks (GAN) and reinforcement learning (RL). GANs learn known attack patterns to synthesize additional attack realizations; however, prior knowledge of attacks is required, which limits their ability to synthesize new unknown attacks. Optimization-based approaches are model-based, requiring accurate system models to synthesize effective attacks, and strong assumptions on the system and/or attack models. In contrast, RL agents can learn new attacks with zero to little prior knowledge of the system and attacks. Further, RL is data-driven, relying on partial system observations, which can involve complex dynamics and inter-dependencies.

Given these advantages, RL can be used for electric grid attack and defense; for example (Q-learning) RL agents to synthesize and develop defense strategies against line-switching attacks that exploit how sudden changes in grid topology can lead to cascading failures and blackout. Additionally, RL can be applied to the synthesis of false data injection (FDI) attacks in power systems, where the RL agent mimics a virus in a compromised power substation attempting to induce voltage sags in the system. A RL approach can also be used to synthesize FDI attacks that can bypass attack detection methods in direct-current (DC) microgrids.

Embodiments of the present disclosure utilize RL for attack synthesis against the electric grid to load frequency control (LFC). Frequency deviation negatively impacts grid operation, security, and reliability, and can potentially result in equipment damage, load performance degradation, transmission line overload, generation loss, and grid instability, amongst others. Due to its critical role in maintaining nominal grid frequency, LFC is a valuable target of cyberattacks. Embodiments of the present disclosure utilize RL to holistically explore an attack space to expose possible attacker strategies in order to help specify attack requirements and verify attack/threat model assumptions to improve electric grid defense.

Advantageously, embodiments of the present disclosure employ RL in the synthesis of attacks against LFC by training RL agents to execute FDI and load switching attack strategies. In this way, embodiments of the present disclosure apply RL to dynamic power system cyber-physical security. Unlike other approaches that generally focus on the RL agent's effect on power flow and state estimation computations, embodiments of the present disclosure act on the power system's dynamics and validate results empirically. Additionally, embodiments of the present disclosure provide an RL reward function that is useable as templates for facilitating the training of RL agents against LFC. The reward functions can be used to reward and train RL agents to relieve or induce stress on the power system by deviating from its nominal states.

Utilizing RL for cyber-physical security has a number of significant advantages, including replicating known attacks, exploring the attack space, revealing potential attack strategies, specifying attack/threat model assumptions, and developing proactive defense strategies. Furthermore, the RL generated data can be used to train a supervised learning-based attack detector, for example, with a long short-term memory (LSTM) neural network. The present inventors have compared such detector with the state-of-the-art unsupervised anomaly detection, based on autoencoders, to demonstrate the benefits of RL-based attack synthesis for defense. In this way, RL attack synthesis described in the present embodiments significantly improves detection-based mitigation.

Generally, LFC maintains power balance and grid frequency through primary, secondary, and tertiary control levels. The primary level generally employs droop-governor control to regulate frequency while the secondary level generally uses automatic generation control (AGC) to regulate the net interchange of power. Tertiary control generally provides additional frequency support mechanisms by restoring power reserve. Failure to regulate frequency can cause frequency protection devices (including ANSI 81U/O/R) to isolate power system equipment in order to protect them from damage sustained due to operation at abnormal frequencies; which results in unwanted system reduction.

Implementations of LFC over wide-area networks, with open communication protocols and minimal human supervision, substantially increases their cyberattack surface. Interference of LFC operation is possible by exploiting a variety of vulnerabilities in insecure legacy electric grid networks, open communication protocols, and operating systems. Additionally, their use can introduce malware through infected emails or USBs, supply-chain attacks, or from disgruntled insiders. These cyberattacks often aim to compromise critical measurement signals to ultimately destabilize the grid.

The present embodiments are particularly apt at addressing cyberattacks aimed at unwanted triggering of frequency protection relays in power grids; which can initiate sudden power imbalance leading to grid instability, cascading failure, and blackout. Attackers can disrupt grid operation by corrupting frequency measurements, by corrupting generation control signals, by compromising loads, and/or by corrupting tie-line or power flow measurements.

Measurement corruption can be accomplished by spoofing physical sensors and global positioning system (GPS) signals or compromising communication channels used for the transfer of sensor data.

Attackers may compromise communication channels transmitting control signals. Alternatively, sophisticated attackers might exploit vulnerabilities in third-party services to the grid and devices' supply chain, allowing them to infect control devices and subsequently corrupt control signals. For example, corrupting the automatic synchronization control devices responsible for re-synchronizing generators or microgrids to the main grid. The control signals from automatic synchronization control devices feed into LFC.

Corrupting frequency, tie-line, or power flow measurements or control signals can cause frequency excursions that trigger frequency, rate-of-change of frequency, or out-of-step relays; resulting in generation loss and power imbalance. In other cases, such attacks can negatively impact automatic generation control and electricity market operation, cause load shedding, cause power swinging between areas, and/or force the system into disintegration, collapse, and cascading failure.

Cyberattackers can also comprise loads by gaining control over a portion of the system load, thereby compromising the devices responsible for switching the load. Such attacks can include compromising electronic load controllers, electric vehicle charging systems, data centers, load control price signals. In addition to the aforementioned effects of compromising measurements, attacks compromising loads can cause circuit overflow on distribution or transmission lines to the detriment of utility company or operator-owner equipment.

Embodiments of the present disclosure advantageously make use of reinforcement learning approaches. Generally, in reinforcement learning, an agent is trained through a process of trial-and-error to achieve optimal decisions or strategies in an environment of which the agent has zero to little prior knowledge. Training an RL agent to attack the electrical system can yield novel unforeseen insight into system vulnerabilities and attack strategies. Establishing an RL problem within the context of synthesising attacks requires defining the environment (representing the cyber-physical system) and specifying what actions (representing attacks) the agent can execute in the environment. It also requires defining what environmental states it can observe and make decisions based on. A reward function is formulated to steer the agent into taking actions that achieve the goals of the attack.

The RL agent contains two components: a policy and a learning algorithm. The goal of the policy is to map environment observations to actions that maximize rewards. The policy can involve an actor, critic, or actor-critic function approximators. An actor π: S→A maps environment observations S to actions A. A critic Q: (S, A)→R maps action-observation pairs to (predicted) discounted cumulative long-term rewards R. The learning algorithm continuously updates the policy in order to find the optimal policy. Learning can happen in episodes, which are simulations that expire after the RL agent achieves a certain goal or a maximum simulation length.

Embodiments of the present disclosure employ deep deterministic policy gradient (DDPG) reinforcement learning as the learning algorithm, which is compatible with continuous actions and observations. Such approach can be used offensively as a cyberattacker or defensively for electric grid cyber-physical security. However, in further cases, any suitable RL learning algorithm can be used, for example, Deep Q-Network, Asynchronous Advantage Actor-Critic, Proximal Policy Optimization, or the like.

Generally, the actions used by the present embodiments can include disturbances and/or injections that affect a dynamical model of an industrial system. The general goal of an attach is to cause a change in the industrial system's dynamics (either by manipulating its natural dynamics or manipulating its controlled dynamics) to drive it away from a desirable, safe operation. These actions can be, for example, changes to the topology, shape, structure, components, operation of the industrial system; such as, opening a switch, removing or adding a load, opening a water tap, or the like. In other cases, the actions can be modifications to data and traffic that a communication infrastructure or network of the industrial system relies on; for example, a cyberattack that injects false data, a cyberattack that delays communication or blocks traffic, or the like. In other cases, the actions can be modifications to control logic; for example, persistently pumping fluid into a tank that is getting over-pressurized.

In embodiments of the present disclosure, a policy is learned which is a function that maps a state of the industrial system to an action. Over the course of training, agents are used to learn to improve this policy so that the actions are of most detriment to the industrial system; i.e., the learned policy determines the actions which likely cause the industrial system to fail.

Generally, during training, a reinforcement learning agent tries different actions on the industrial system during a simulation of the system. In most cases, the actions can be sequential; meaning the reinforcement learning agent executes a sequence of actions on the industrial system over a pre-determined time-interval (called a ‘training episode’). In this way, it can be determined whether the reinforcement learning agent can cause the industrial system to fail within the episode; and if not, it is determined how detrimental the reinforcement learning agent get the industrial system to be. The actions sequence can be evaluated based on how much such actions urge the industrial system into an undesired mode of operation. If the actions cause more undesirable outcomes, the reinforcement learning agent is encouraged to try more similar sequences to keep causing these negative outcomes. During training of the reinforcement learning agents, sequences of actions can be logged with their outcomes and impact.

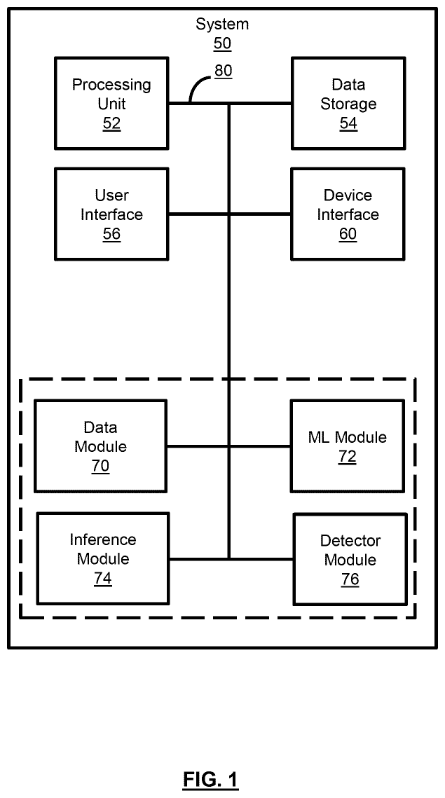

FIG. 1 illustrates a conceptual diagram of a system 50 for determining actions that disrupt or compromise to the industrial system for use in determining vulnerabilities of the industrial system, in accordance with an embodiment. The system 50 can be run on any suitable computing device, for example, on a general-purpose computing device, on a purpose-built controller, on cloud-hosted servers, or the like. In some embodiments, the components of the system 50 are stored by and executed on a single computer system or controller. In other embodiments, the components of the system 50 are distributed among two or more computer systems or controllers that may be locally or remotely distributed.

FIG. 1 shows various physical and logical components of an embodiment of the system 50. As shown, the system 50 has a number of physical and logical components, including a processing unit 52, a data storage 54, a user interface 56, a device interface 60 and a local bus 80 enabling the processing unit 52 to communicate with the other components. The processing unit 52 executes various modules, as described herein in greater detail. The data storage 54 provides responsive data storage to the processing unit 52, such as via a suitable non-transitory computer-readable storage medium, and can store any required data such as computer-executable instructions for implementing the modules, as well as any data used by these services. The user interface 56 enables an administrator or user to provide input via an input device, for example a keyboard and mouse. The user interface 56 can also output information to output devices to the user, such as a display and/or speakers. The device interface 60 permits communication with various external equipment to use with the system 50 to make or support decisions for external systems; for example, the cybersecurity alerts for the electrical grid.

In an embodiment, the processing unit 52 can execute a number of conceptual modules, which can include a data module 70, an ML module 72, and an inference module 74, and a detector module 76. In some cases, the functions and/or operations of the conceptual modules can be combined or executed on other modules.

The system 50 trains RL agents to execute attacks against the LFC that directly lead to protection tripping and loss of generation. For example, the agent can be deployed through a cyber-breach related to an FDI attack or can be integrated into malicious software that is uploaded onto a target control device, such as in a Programmable Logic Controller (PLC) rootkit attack.

In some cases, the system 50 assumes that the electric grid exhibits oscillatory eigenmodes that can be leveraged for disruption. Generally, generators' mechanical construction gives rise to their own eigenmodes. The existence of inter-area oscillatory eigenmodes is evident in most multi-machine power systems. Using the oscillatory eigenmodes, the attacker can perform one of many actions, amongst others, (a) corrupt frequency (sensor) measurements, (b) corrupt generation control signals, (c) corrupt tie-line or power flow measurements, or (d) compromise loads.

In some cases, the system 50 assumes that the attacker can observe the grid frequency; which is considered to be a global power system state through the utilization of a frequency counter or spectrum analyzer device connected to the power supply of a load, such as a residential plug. Alternatively, if the attacker has infiltrated the network, the attacker can eavesdrop on sensor data to observe the frequency value. In the context of a rootkit attack, the agent will be able to observe frequency measurements transmitted to the compromised device. With the frequency measurement, the attacker can compute the grid frequency's derivative (rate of change) and/or time-integral.

Generally, the system 50 assumes that the attacker does not have any knowledge of the physical dynamics or characteristics of the system; hence, the RL agent of the present embodiments is initialized with zero knowledge of its environment.

Although an attacker must apply strategic foresight and action to gain the access required for executing an FDI or rootkit attack, there is nonetheless a growing vulnerability and attack surface for industrial control systems within the electric grid; which lowers the associated effort required to attack. The challenge for an attacker is to devise a strategy to inject false commands or corrupt control software, aiming to destabilize or cause damage to the grid. The challenge becomes more complex when the attacker lacks prior knowledge of the system and must rely on minimal system observations as the available information to plan the attack.

Advantageously, the system 50 can include a dynamical power system model and machine learning models, within an RL framework, to attack and defend LFC. The LFC can be modelled in the RL environment and the RL agents can be developed, which are used to construct, in some cases, an unsupervised anomaly detector and supervised attack detector.

A swing equation can be used to model LFC. The following state-space system expresses the linear load-frequency dynamics:

$$\dot{x} = Ax + Bu + Wp \qquad ( 1 )$$

$$where the state is :$$

$$x = {[ \begin{matrix}Δ e & Δ {P}_{g} & Δ {P}_{m} & Δ ω & Δ \hat{ω} & \hat{\dot{ω}}\end{matrix} ]}^{T} \qquad ( 2 )$$

Δ represents the deviation from the point of linearization of the dynamical system; e is governor-droop control signal, P_{g}, the governor output, Pₘ, the mechanical power, ω, the system frequency, \hat{ω}, the frequency measurement, and \dot{\hat{ω}}, the rate of change of frequency measurement. In an example, the state matrices can be as follows:

$$\dot{x} = [ \begin{matrix}0 & 0 & 0 & - ( kB ) & 0 & 0 \\ 1 / {τ}_{G} & - 1 / {τ}_{G} & 0 & - d / ( {τ}_{G} ) & 0 & 0 \\ 0 & 1 / {τ}_{T} & - 1 / {τ}_{T} & 0 & 0 & 0 \\ 0 & 0 & 1 / M & 0 & 0 & 0 \\ 0 & 0 & 0 & 1 / {τ}_{ω} & - 1 / {τ}_{ω} & 0 \\ 0 & 0 & 1 / ( M {τ}_{v} ) & - D / ( M {τ}_{v} ) & 0 & - 1 / {τ}_{v}\end{matrix} ] \text{} x + [ \begin{matrix}0 & 0 \\ 0 & - κ \\ 0 & 0 \\ - 1 / M & 0 \\ 0 & 0 \\ - 1 / ( M {τ}_{v} ) & 0\end{matrix} ] u + [ \begin{matrix}- ( kB ) & k & - k & 0 \\ 0 & 0 & 0 & 0 \\ 0 & 0 & 0 & 0 \\ 0 & 0 & 0 & - 1 / M \\ 0 & 0 & 0 & 0 \\ 0 & 0 & 0 & - 1 / ( M {τ}_{v} )\end{matrix} ] p$$

The input vectors u and p represent the inputs to the systems during normal operation and attacks, respectively. The input vector:

$$u = {[ \begin{matrix}Δ {P}_{L} & Δ {P}_{t i e}\end{matrix} ]}^{T} \qquad ( 3 )$$

includes change in the demand, P_{L}, and tie-line power, Pₜᵢₑ, if any. The attack vector:

$$p = {[ \begin{matrix}{p}_{1} & {p}_{2} & {p}_{3} & {p}_{4}\end{matrix} ]}^{T} \qquad ( 4 )$$

includes actions the attacker can execute that are enumerated in the threat model, including corrupting frequency measurements to the control center (p₁), corrupting generation control signals (p₂), corrupting tie-line power measurements (p₃), and compromising load switching (p₄).

A primary objective of an attacker during a system destabilization attack is to induce a sudden power imbalance, which can subsequently lead to cascading failures and blackouts. For example, this power imbalance can be achieved by tripping generation.

Frequency relays play a vital role in safeguarding generators from operational damage caused by operating at unsafe frequencies. These relays ensure that the frequency and its rate of change remain within a predefined safe set [symbol] . This safe set is characterized by specific limits imposed on the frequency and its rate of change, defining the acceptable operating range for the generator. Whenever these limits are surpassed, frequency protection functions are activated, leading to the disconnection of the generator. In an example, three frequency relay functions can be used: under-frequency (UF), over-frequency (OF), and rate-of-change of frequency (ROCOF). These functions impose the following safe set:

$$𝒮 = \{ ( \hat{ω} , \hat{\dot{ω}} ) : UF \leq \hat{ω} \leq OF , \hat{\dot{ω}} \leq ROCOF \} \qquad ( 5 )$$

In an example of recommended industry standards, the following relay settings are provided by Institute of Electrical and Electronics Engineers (IEEE) 1547; which are detailed in Table 1.

TABLE 1

| Protection | | |
|---|---|---|
| Function | Threshold | Clearing time |
| OF | 62.0 Hz | 160 ms |
| UF | 56.5 Hz | 160 ms |
| ROCOF | 3 Hz/s | |

The LFC model specified in Equation (1) can serve as the basis for an RL environment. Within this environment, the RL agent generated by the system 50 models the cyber attacker and performs training to learn how to compromise LFC. It is assumed that the attacker can observe the system frequency. The actions {p₁, p₂, p₃}, entailing the corruption of communicated data, can be modelled as continuous-valued. In practice, the attacker's capacity to inject an attack signal and remain stealthy is limited by physical constraints, restrictions imposed by the communication protocol, or the need to avoid detection by bad data detectors. Hence, the attack vector p is bounded. The bounds assigned to the FDI attack point values {p₁, p₂, p₃} can be selected to represent the range of physical values expected during normal operation. By increasing these bounds, it is possible to simulate attacks where an attacker has greater flexibility to inject more aggressive assaults. Conversely, reducing the bounds allows for simulations of more restricted attacks.

In an example, an attacker can use load switching, in one of two scenarios, for the attack. In a first scenario, an aggregate load is compromised; which encompasses a group of unsecured loads that can be selectively switched on and off. Denoting the maximum capacity of all loads in this aggregate load with P_{sw}, the variable p₄ can be modelled as a continuous-value action within the range [0, P_{sw}]. This scenario is applicable to load alteration attacks against, for example, demand response and electric vehicle charging; whereby individual loads are reduced or added by the attacker to create disruption.

In the second scenario, an attacker can only switch the entire load on or off, leading to a discrete-value action for p₄ where p₄∈P_{sw}×{0,1}. The deep deterministic policy gradient (DDPG) RL actions in this case can be as follows:

$${p}_{4} = \{ \begin{matrix}0 & if {p}_{4} < {P}_{sw} / 2 \\ {P}_{sw} & if {p}_{4} \geq {P}_{sw} / 2\end{matrix} \qquad ( 6 )$$

In this way, a DDPG can be used to attack LFC. In such case, the RL agent observes the system state S=(\hat{ω}, \dot{\hat{ω}}) and influences the power system by injecting an attack action A through the input vector p. The learning objective is for the RL agent to learn a policy π:S→A to force the states in S outside the safe set [symbol] , effectively triggering a frequency protection device. The attacker can then execute this policy to attack and destabilize the real power system. All episodes can be stored in a dataset for training the supervised-learning attack detector. An example of the DDPG neural network architecture and training hyperparameters are detailed in Table 2.

TABLE 2
Actor Network

| Layer | # of units | Hyperparameters |
|---|---|---|
| Input | 2 (Δ\hat{ω}, \hat{\dot{ω}}) | M = 128 |
| Normalization | 2 | α_{θ} = 10⁻⁴, α_{φ} = |
| | | 10⁻³ |
| Fully-connected | 100 | γ = 0.99 |
| ReLU | | τ = 10⁻³ |
| Fully-connected | 50 | N~ [symbol] (0, 0.3) |
| ReLU | | |
| Tanh (or | | |
| Sigmoid) | | |
| Scaling | 1 | |
| Output | 1 (A) | |

Critic Network

| Layer | # of units | Layer | # of units |
|---|---|---|---|
| Input | 2 (Δ\hat{ω}, \hat{\dot{ω}}) | Input | 1 (A) |
| Normalization | 2 | Normalization | 1 |
| Fully-connected | 100 | Fully-connected | 50 |
| ReLU | | | |
| Fully-connected | 50 | | |
| ReLU | 50 | | |
| Tanh (or | | | |
| Sigmoid) | | | |
| Scaling | 1 | | |
| Output | 1 Q(Δ\hat{ω}, \hat{\dot{ω}}, A) | | |

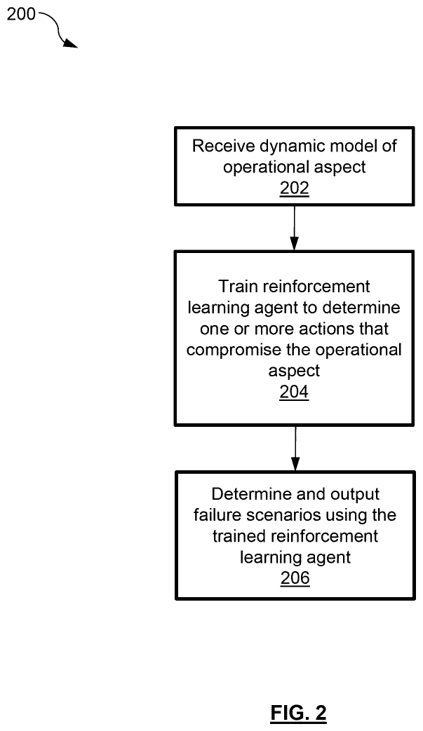

FIG. 2 is a flowchart for a method 200 for determining actions that disrupt or compromise to the industrial system for synthesis of failure scenarios in the industrial, for use in determining vulnerabilities in the industrial system, in accordance with an embodiment. At block 202, the data module 70 receives a dynamical model of operation of the industrial system, such as data representing one or more operational aspects. In the example of a power system, the dynamical model can be load frequency control of the power system.

At block 204, the ML module 72 iteratively trains one or more reinforcement learning agents to determine one or more actions that compromise the operation of the industrial system when applied to the dynamical model. Generally, the dynamical model takes as input the actions and represents resulting changes to the industrial system. The training can include observing a state of the industrial system after one or more disruptions have occurred and training the reinforcement learning agent to learn a learned policy that forces the industrial system into an unfavorable mode of operation by forcing a dynamical state of the industrial system outside of a safe set. In the example of a power system, the one or more actions can be attack point values that compromise the LFC; where the one or more actions comprise corruption of communicated data. In the power system example, the training can include observing a state of the power system after injecting the attack point values and then training the reinforcement learning model to learn a policy that forces the state of the power system outside of the safe set.

At block 206, the ML module 72 determines failure scenarios of the industrial system using the trained reinforcement learning agent and outputs the determined failure scenarios to the data storage 54. In further cases, instead of determining and outputting the failure scenarios, the ML module 72 can output the trained reinforcement learning agent for use in determining the failure scenarios.

In an example, for power systems, DDPG RL can use the following approach for attacking LFC:
Initialize a mini-batch size M, actor and critic learning rates α_{θ}, α_{φ}, a discount factor γ, a target smooth factor τ, an episode length, and a training step length;
Define an action space [symbol] and noise distribution;
Initialize critic Q(S, A; φ) and target critic Qₜ(S, A; φₜ) neural networks with random parameters φ=φₜ;
Initialize actor π(S; θ) and target critic πₜ(S; θₜ) neural networks with random parameters θ=θₜ;
For each training episode, do:
   For each training step, do:
      For the current observation S=(\hat{ω}, \dot{\hat{ω}}), select an action such that A=π(S; θ)+N with noise N;
      Execute action A as an attack on the power system through one of the inputs in p. Observe the reward R and the next observation S′;
      Store the experience (S, A, R, S′) in the experience buffer;
      Sample a random mini-batch of M experiences (Sᵢ, Aᵢ, Rᵢ, S′ᵢ) from the experience buffer;
      For each sampled experience, do:
         Determine the value function target yᵢ;
         If S′ᵢ is a terminal state, then:

$${y}_{i} = {R}_{i} \qquad ( 7 )$$

else:

$${y}_{i} = {R}_{i} + γ {Q}_{t} ( {S}_{i}^{′} , {π}_{t} ( {S}_{i}^{′} ; {θ}_{t} ) ; {ϕ}_{t} ) \qquad ( 8 )$$

end;
end;
Compute a loss over mini-batch as:

$$L = \frac{1}{M} {\sum }_{i = 1}^{M} {( {y}_{i} - Q ( {S}_{i} , {A}_{i} ; ϕ ) )}^{2} \qquad ( 9 )$$

Update critic parameters by minimizing over L:

$$ϕ ← ϕ - {α}_{ϕ} \frac{\partial L}{\partial ϕ} \qquad ( 10 )$$

Update actor parameters by descending policy gradient:

$$\frac{\partial J}{\partial θ} ← \frac{1}{M} {\sum }_{i = 1}^{M} \frac{\partial }{\partial A} Q ( {S}_{i} , A ; ϕ ) \frac{\partial }{\partial θ} π ( {S}_{i} ; θ ) \qquad ( 11 )$$

$$θ ← θ - {α}_{θ} \frac{\partial J}{\partial θ} \qquad ( 12 )$$

End episode if S∉ [symbol] , and label S as a terminal state; Store episode data;
Update the target actor and critic parameters periodically:

$${ϕ}_{t} = τ ϕ + ( 1 - τ ) {ϕ}_{t} \qquad ( 13 )$$

$${θ}_{t} = τ θ + ( 1 - τ ) {θ}_{t} \qquad ( 14 )$$

end;
end.

In other cases, unsupervised machine learning approaches can be used to detect potential cyberattacks by learning patterns and regularities in normal operational data and flagging anomalies. Due to the lack of labelled cyberattack datasets, unsupervised learning approaches, particularly autoencoder-based detectors, are particularly useful for attack detection.

Autoencoders generally consist of a deep neural network, partitioned into an encoder and decoder connected in series, that is trained to reconstruct its input (at the encoder) at its output (of the decoder). Within the autoencoder, the encoder maps its input to a compressed hidden representation based on regularities in the data, and its decoder attempts to map this representation back to the input data. When an autoencoder trained on a particular type of data, such as normal operational data in the power grid, is applied to new data with distinct characteristics, for example from a cyber attack, a large variation is observed between the input data and the autoencoder's reconstruction, indicating an anomaly that can then be classified as an attack.

To simulate normal operation data, in some cases, a stochastic approach can be used. In an example, two stochastic functions can be used to characterize power demand. One of these functions accounts for uncertainty (noise), while the other captures volatility (load changes). In an example, the change in demand can be modelled as a 1-second-per-step random walk, sampling from a Gaussian distribution [symbol] (0,

$$( 0 , {σ}_{1}^{2} )$$

to represent uncertainty. Additionally, in some cases, a 5-minute-per-step random walk can be superimposed that samples from a Gaussian distribution [symbol] (0,

$$( 0 , {σ}_{2}^{2} )$$

to represent uncertainty. This combined approach enables simulation of the dynamic behavior of the power demand, capturing both the inherent uncertainty and the changing nature of the demand over time.

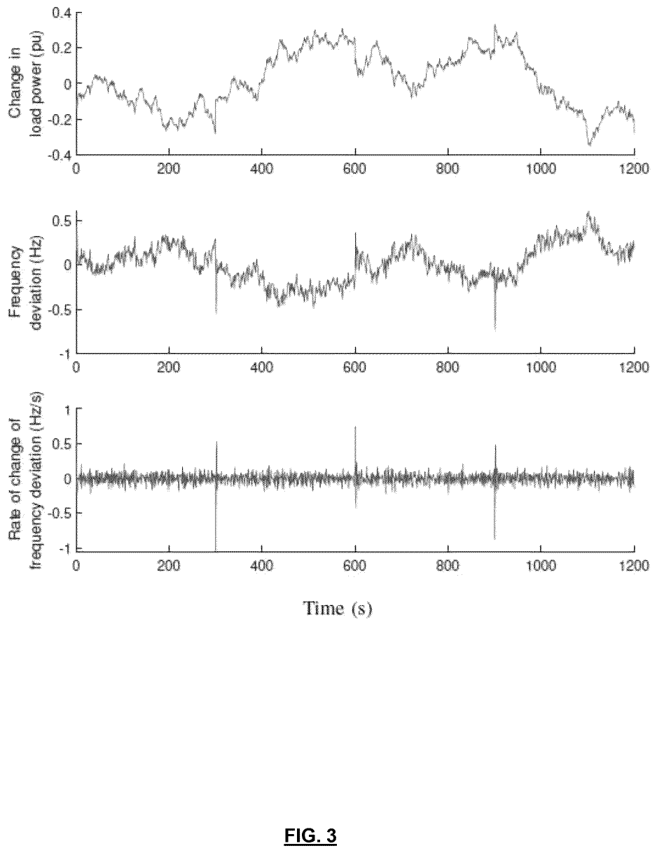

FIG. 3 illustrates change in load power as simulated by a random process and the resulting frequency and rate of change of frequency deviation. The stochastic process in this example has σ₁=(0.05/3) and σ₂=(0.2/3) to simulate normal grid operation data.

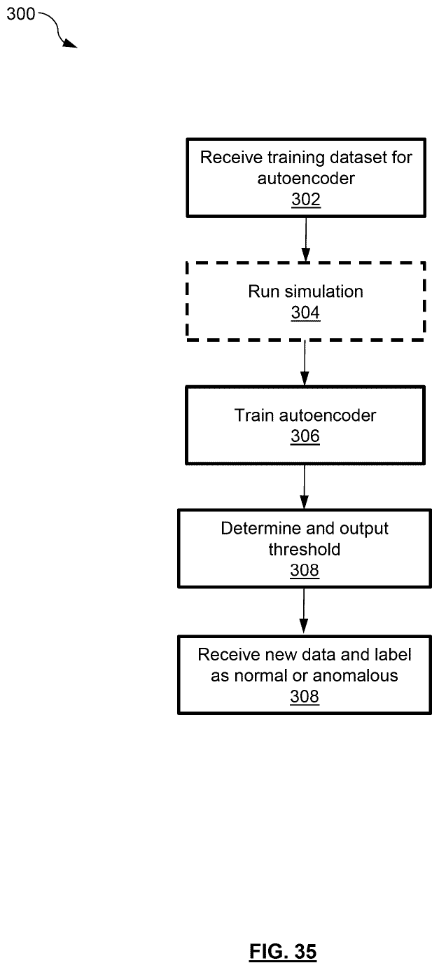

FIG. 35 illustrates a flowchart of a method 300 for attack synthesis on power systems by detecting anomalies using an autoencoder, in accordance with an embodiment. The autoencoder is used to detect anomalies in a time-series consisting of a governor-droop control signal e and a frequency measurement \hat{ω}. At block 302, the data module 70 receives a training dataset to train the autoencoder.

In some cases, to prepare the training dataset, at block 304, the data module 70 runs a simulation of normal system operation and then randomly crops N portions. The portions are sampled at 50 milliseconds per sample and have variable (time) length. Each portion is a vector Xᵢ∈ [symbol] ^{2×n}^{ᵢ} vector representing a time-series of (e,\hat{ω}), where nᵢ is the number of samples in the portion. In other cases, block 304 can be omitted as the training dataset will have already run a number of simulations and collected the data from all the simulations.

At block 306, the ML module 72 trains the autoencoder using the training dataset. The overall autoencoder can be expressed as a mapping fₐₑ:Xᵢ→\hat{X}ᵢ between the input data Xᵢ and its reconstruction \hat{X}ᵢ, where fₐₑ(X;φ) is a neural network with parameters φ. In a particular case, a long short-term memory (LSTM) neural network-based autoencoder can be used given the suitability of LSTM networks for time-series; however, any suitable machine learning model can be used for the autoencoder. The ML module 72 trains the autoencoder by seeking to minimize the mean square error between the training data and their reconstructions:

$${L}_{M S E} = \frac{1}{N} {\sum }_{i = 1}^{N} \frac{1}{2} {( {\hat{X}}_{i} - {X}_{i} )}^{2} \qquad ( 15 )$$

At block 308, the ML module 72 determines and outputs a threshold based on the maximum reconstruction error (seen in the validation set) to differentiate between normal and anomalous data.

At block 310, the inference module 74 receives new input control signal and frequency input data of the power system and determines whether the reconstruction error is below the threshold, and labels and outputs such data as normal; otherwise, the inference module 74 labels and outputs the input data as anomalous.

In most cases, the data generated by the RL agent is not employed in training the autoencoder for anomaly detection. Instead, in some cases, it can be used for validating the anomaly detector's accuracy in identifying anomalous data (specifically anomalies stemming from the RL agent attack attempts.)

In some cases, synthesis of failure scenarios in an industrial system using reinforcement learning can use supervised models that are trained to distinguish between normal operation and attacks by training on labelled system data. Reinforcement learning (RL) can provide the labeled data necessary to train supervised methods for detecting attacks and categorizing them based on their impact. In such cases, to collect labelled data, the data module 70 augments the training dataset (which was used to train the autoencoder) with an RL-generated dataset. The data module 70 labels the training data into 4 categories: (1) normal operation, and attacks that (2) do not trigger protection, (3) trigger under-frequency (UF) or over-frequency (OF) protection, and (4) trigger rate-of-change of frequency (ROCOF) protection. Hence, category (1) comprises data collected in the absence of the RL agent. Categories (2) through (4) comprise data representing simulations of the RL agent attempting attacks. The labels reflect the observed impact of the attack (directly from the simulations), which may or may not include protection triggering.

In most cases, RL agent attempts that do not result in the triggering of protection are categorized under label (2) as attacks that do not trigger protection; such attempts are not labelled as normal. Training the attack detector to distinguish between categories (1) and (2) can assist in identifying instances where an attacker is probing the system or in early threat prevention by detecting unsuccessful attack attempts.

Each record in the dataset includes a Xᵢ∈ [symbol] ^{2×n}^{ᵢ} vector representing a time-series control signal and frequency measurement and a label [symbol] ᵢ∈ [symbol] ={1,2,3,4}.

In some cases, the learned policy can be used to train a supervised machine learning model to categorize patterns of anomalies in the operational data of the industrial system; for example, such anomalies can include intentional attacks and anomalous non-intentional circumstances that occur to the industrial system. The supervised machine learning model takes monitoring data of the industrial system as input. The supervised machine learning model can be integrated into security systems for the industrial system, where their role will be to monitor the system data. If the data contains patterns of anomalies sequences seen in the dataset, then, for example, the supervised machine learning model will be able to detect it, categorize it per its label, and signal security personnel. The ability to detect and categorize is enabled by training the supervised machine learning mode on the policy/dataset gathered from training of the reinforcement learning agents. The supervised machine learning model can output labels; for example, representing attack classes (e.g., false data injection, denial of service, or the like), potential failure scenarios (e.g., under-frequency or over-frequency for a power system, or front crash, side crash, rear crash for an automobile), and/or urgency of attention to anomaly (low, medium, high, critical). In some cases, the learned policy can be used to validate and evaluate existing security defenses. For example, anomaly detection using autoencoders.

In some cases, the detector module 76 trains a supervised attack detector to classify the data in the augmented training data to their correct labels. The attack detector consists of a neural network f_{ad}: Xᵢ→

$$\{ {P}_{i}^{( c )} \}$$

mapping the input data Xᵢ to the probability of Xᵢ belonging to each category, where

$${P}_{i}^{( c )}$$

is the probability of Aᵢ belonging to category c∈ [symbol] . The category with the highest probability is chosen as the label for instance. Training the detector seeks to minimize the cross-entropy loss:

$${L}_{CE} = - {\sum }_{i = 1}^{N} {\sum }_{c ∈ 𝒞} \{ {ℓ}_{i} = c \} log ( {P}_{i}^{( c )} ) \qquad ( 16 )$$

In a particular case, the attack detector can be an LSTM neural network-based given its suitability for time-series and for comparison between the supervised and unsupervised attack detections; however, any suitable machine learning model can be used.

In an example, to determine the neural architecture of the LSTM network, a hyperparameters search can be performed that focuses on the number of layers and units per layer. In this example, the search can span from 1 to 3 layers and 10 to 150 units per layer, incrementing by 5 units at a time. The neural architecture can be selected by determining which architecture achieves the highest accuracy. Furthermore, taking into consideration the computational complexity of the detector, the neural architecture that demonstrates the highest accuracy can be determined (for example, surpassing 98%), while being the least computationally demanding.

In some cases, the anomaly detector and the attack detector are deployed within the grid; for example, deployed on governor intelligent electronic devices (IED) of the generator. The IED can be upgraded to collect measurements of the governor control signal and local frequency. The IED can store the last nᵢ₋₁ measurement samples, add the latest sample, and perform the neural network computations to classify the system data. The classification can be communicated to the grid operator Supervisory Control and Data Acquisition (SCADA) system to alert on attacks, or actions can be programmed into the IED to autonomously mitigate detected attacks.

The present inventors conducted example experiments to provide empirical evidence of the capability of the system 50 for determining cyberattackers and synthesizing attacks that compromise LFC.

In the example experiments, the RL agent was trained within an RL environment that is based on a simplified linear LFC model. The use of this simple, linear model considerably reduced the computational resources and time required to train the RL agent. Nevertheless, the attack policy learned by the RL agent through interaction with this simplified model is highly adaptable and can effectively be applied to compromise LFC in testbeds of higher complexity.

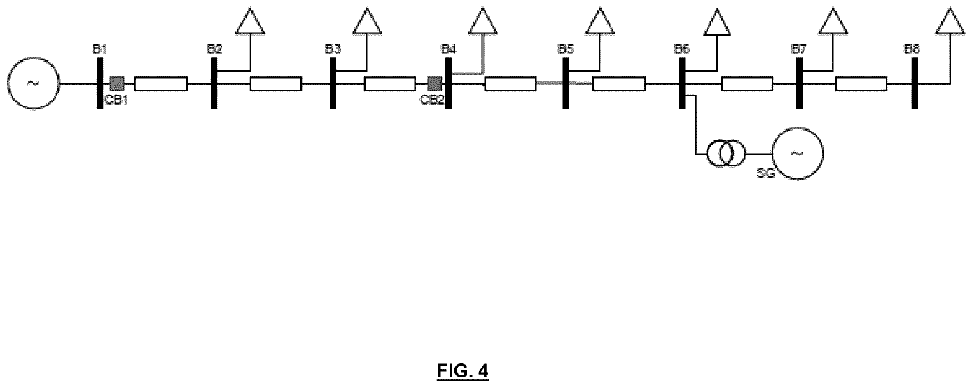

The example experiments demonstrated the RL agent's ability in compromising LFC across three different detailed microgrid testbeds (MG1 to MG3). These testbeds share the same network layout, as illustrated in FIG. 4, but differ in their LFC parameters. The base microgrid: MG1 replicates a 2.5 MVA rated microgrid situated in rural Ontario, Canada. FDI attacks impact the control of a synchronous generator (SG in FIG. 4), while load switching attacks compromise the operation of one or more of the microgrid's loads. Subsequently, the use of the attack data generated during the RL agent's training can be used to: (1) design defenses through the training of a supervised attack detector; and (2) test defenses through the validation of an unsupervised anomaly detector. FIG. 4 illustrates a microgrid testbed, where SG is the synchronous generator which is the target for the attacks.

Generally, the example experiments were conducted on a microgrid testbed, motivated by the high susceptibility of microgrid networks to cyberattacks and their vulnerability to cyber-physical attacks that can compromise their stability due to their low inertia. The frequency control mechanisms in microgrids resemble those employed in transmission systems and the coordination of multiple power generation areas via automatic generation control (AGC) mirrors the coordination of multiple interconnected microgrids.

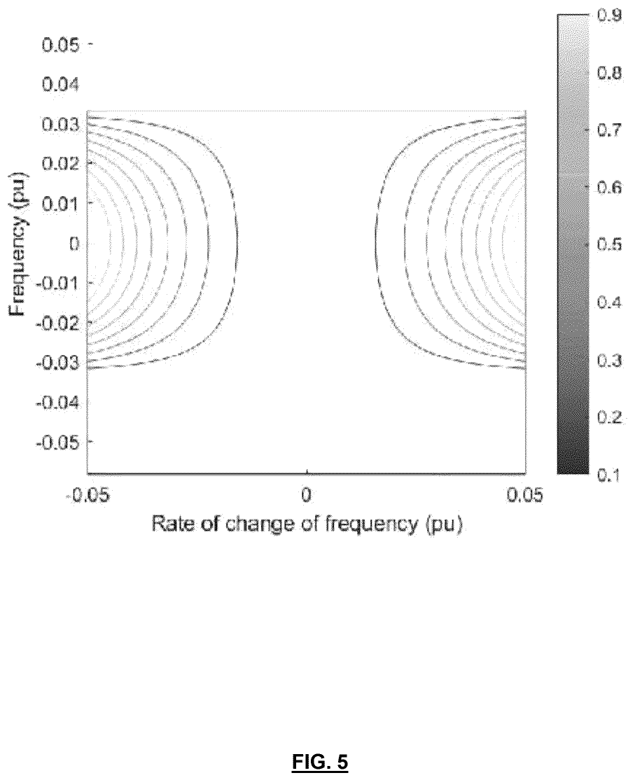

In some cases, as described herein, the system 50 can use a DDPG RL agent to inject false data into any of the inputs {p₁, p₂, p₃} of a single-area system while observing the frequency and its rate of change. The results of the following example experiments are specific to corrupting the frequency measurement to the control center (p₁); but are generally applicable to the other inputs. Following experimentation, the following decisions were made in the design of the RL agent:
The RL action space was bound, representing the injected frequency bias, to [−0.1,0.1] pu. The large action space makes it easier and faster for the RL agent to learn successful attack strategies and generate a larger variety of attacks. Smaller bounds lead to longer convergence times during training. After training, the RL action space can be scaled down to smaller, more practical bounds to destabilize vulnerable power systems. For example, the RL agent's actions in the detailed model time-domain simulations were restricted to the range [−3.5,2]/60 pu to match the frequency range (56.5 to 62 Hz) in which the generator regulates the system frequency. This choice is based on recognizing that a system disturbance, under normal circumstances, may cause the system frequency to fluctuate within this frequency range. In response, the generator will take action to stabilize the system frequency. As a result, the action space encompasses values that are expected during normal operation. This may potentially make the detection or post-failure analysis of falsified frequency measurements more challenging. Conversely, values falling outside of this range could be easily identified as anomalous by simple detection measures.
The large action space allows the agent to quickly discover a simple bias attack to trigger UF or OF protection. A reward function is used to encourage the agent to discover more complex attacks. The reward function is illustrated in FIG. 5. The safety set [symbol] is what the agent attempts to force the system to exit. The reward function can be based on a potential-based distance heuristic RL shaping functions and can be augmented with high sparse rewards granted to the agent upon triggering protection. A potential-based distance heuristic RL shaping function accelerates the agent learning by providing rewards that are proportional to the agent's progress towards the goal. Here, the agent is rewarded for increasing the rate of change of frequency towards and beyond the ROCOF relay setting while maintaining the frequency deviation small. Additionally, the agent attains a high reward of +20 when the ROCOF relay trips and a high penalty of −20 when either of the UF or OF relays trips. Without the penalization, the agent continues to prefer simple actions that trigger UF or OF protection. The example experiments show that generally following the above guidelines facilitates RL training.
Each episode in the example experiments is limited to 15 seconds to encourage the agent to destabilize the system quickly, and end the episode when the agent succeeds in triggering protection.

FIG. 5 illustrates the FDI attacks reward function, where the agent is rewarded for increasing the rate of change of frequency while maintaining small frequency deviation. The FDI attacks reward function is implemented such that the agent is rewarded for increasing the rate of change of frequency while maintaining small frequency deviation:

$${R}_{i} = {( \frac{\hat{\dot{ω}}}{0.05} )}^{2} \cdot max ( 0 , 1 - {( \frac{\hat{ω}}{0. \dot{3}} )}^{2} ) + 20 \{ \hat{\dot{ω}} ∉ 𝒮 \} - 20 \{ \hat{ω} ∉ 𝒮 \} \qquad ( 17 )$$

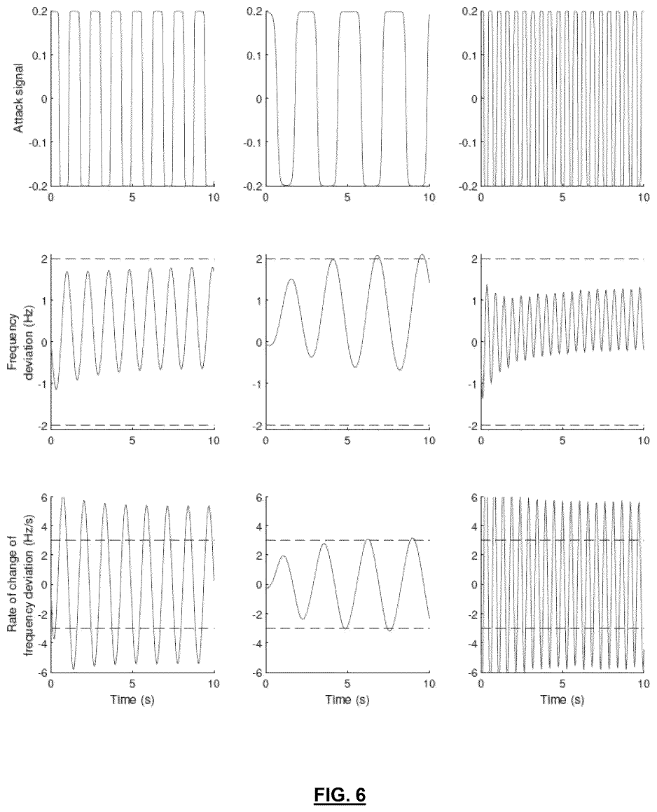

The agent generates an oscillatory frequency bias to excite the mechanical eigenmode of the microgrid, leading to generation tripping in vulnerable microgrids. FIG. 6 shows time-domain simulations of two vulnerable microgrid testbeds, each with a different eigenmode frequency, demonstrating the ability of the RL agent to attack different systems. Each column corresponds to a different system, with eigenmodes located at (left: MG2) 4 and (right: MG3) 3.4 rad/s. The top plot in each column depicts the injected attack signal, with the frequency and rate of change of frequency deviation plot below it. The horizontal dashed lines indicate the ROCOF protection relay bounds, which trigger the corresponding relay function and cause generation tripping when exceeded. For demonstration purposes, the relay triggering is suppressed to continue to demonstrate the RL agent's attack strategy. The agent successfully triggers the ROCOF relay function in the systems. FIG. 6 demonstrates the RL agents' adaptability. Being data-driven, it can easily adjust attacks to destabilize different systems. The agent utilizes easily available system frequency measurements to tailor the frequency of its injected attack signal to the mechanical eigenmode of the system.

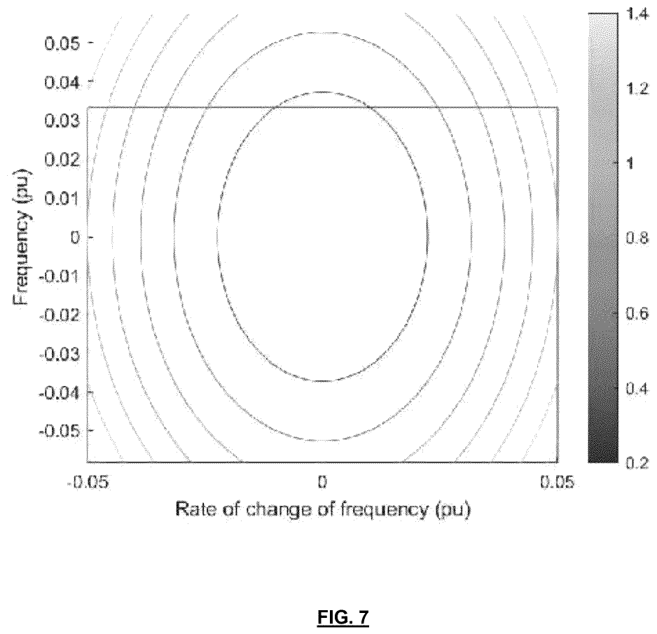

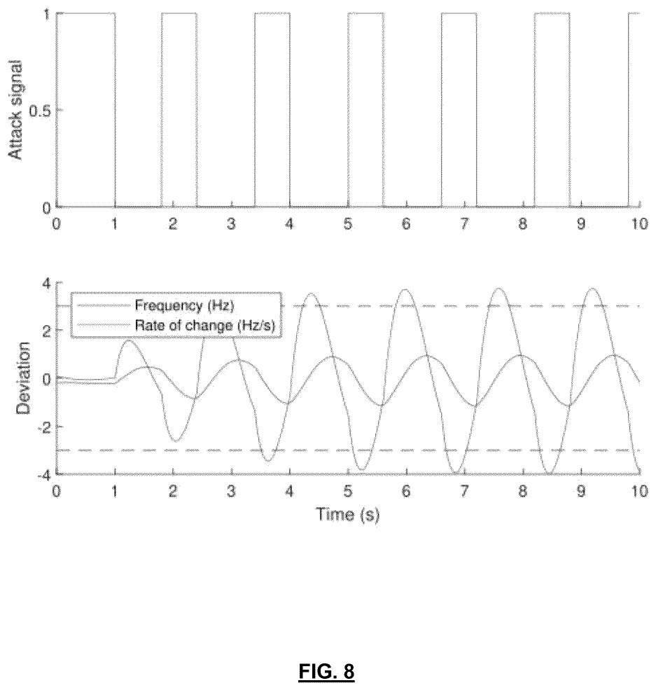

FIG. 7 illustrates a load switching attack reward function. The agent is rewarded for increasing the frequency deviation and its rate of change towards the protection relay settings. FIG. 8 shows results of a detailed model simulation for a load switching attack against MG1. The load is switched on and off when the attack signal is 1 and 0, respectively. Generation is tripped when the rate of change of frequency exceeds the ROCOF's relay settings (dashed).

For load switching attacks, the RL agent further learns to execute load switching attacks by manipulating the system load through p₄, while monitoring the frequency and its rate of change. The reward function of Equation (18) was used to incentivize the agent to increase the frequency or rate of change of frequency deviations, with high rewards of +20 earned when any of the UF, OF, or ROCOF relays trip. The change in the reward function (from Equation (17)) is attributed to the difficulty of tripping UF/OF protection with switching attacks.

$${R}_{i} = {( \frac{\hat{\dot{ω}}}{0.05} )}^{2} + {( \frac{\hat{\dot{ω}}}{0.08 \dot{3}} )}^{2} + 20 \{ ( \hat{ω} , \hat{\dot{ω}} ) ∉ 𝒮 \} \qquad ( 18 )$$

FIG. 8 shows time-domain simulations of a fixed load switching attack, wherein 464 KW (0.18 pu) of MG1's load is switched on (1) and off (0), thereby exciting the mechanical eigenmode and eventually tripping the generation.

In this way, the RL agent can embody an effective, adaptive attack policy. A cyberattacker can employ this policy to compromise LFC during a security breach. The agent can be programmed as malicious software or used to make decisions regarding actions to inject in an FDI attack to destabilize the targeted system.

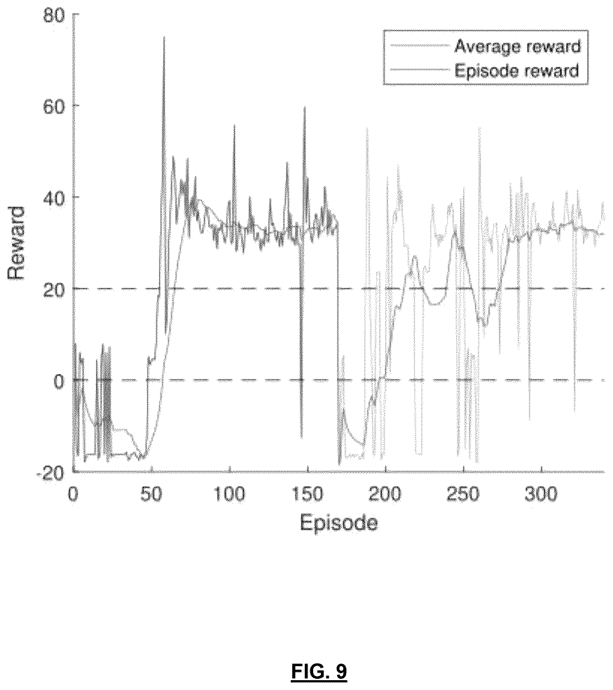

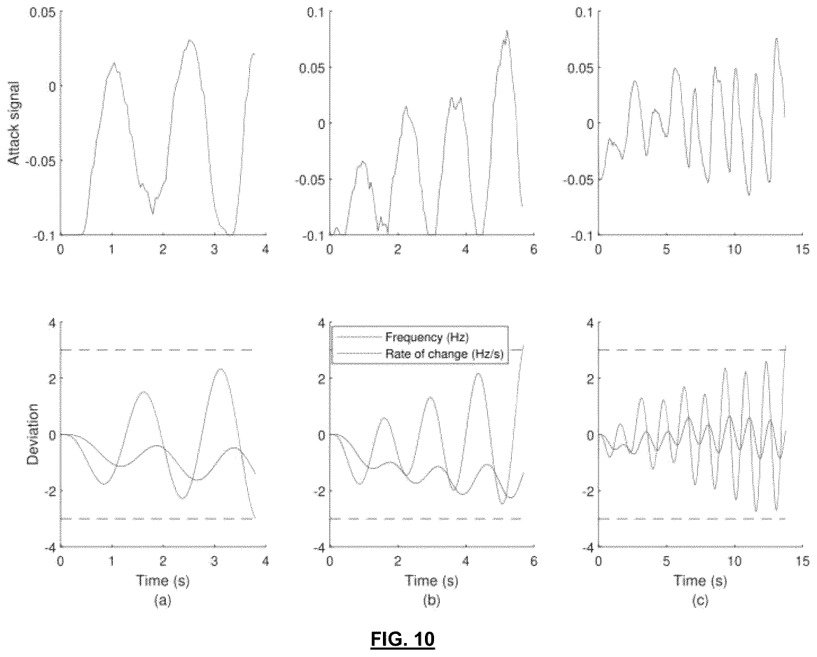

FIG. 9 illustrates RL agent episode rewards and average rewards over 20 episodes for supervised attack detection. FIG. 10 illustrates different FDI attacks against MG2. The attack signal in the top charts is the per-unit injected frequency bias.

For supervised attack detection, the RL agent is trained to generate a large attack dataset to train a supervised-learning attack detector. The learning progress of the RL agent is illustrated in FIG. 9, taking into account the reward function defined in Equation (17). Instances where the reward exceeds the dashed line at +20 indicate successful triggering of ROCOF protection. Episodes with rewards between the 0 and +20 lines represent unsuccessful attacks, while episodes with rewards below the 0 line indicate inadvertent triggering of UF or OF protection by the agent. These reward ranges correspond to three categories that the attack detector is trained to classify.

Multiple rounds of learning may be necessary to further explore potential attacks and collect data points for the detection algorithm's datasets. After the initial learning round depicted by the curve in FIG. 9 converges, the system 50 randomizes the neural network weights of the RL agent to initiate another learning round. FIG. 9 demonstrates that the RL agent rapidly learns successful attacks to trigger ROCOF protection within approximately the first 70 episodes, and its learning converges efficiently. The formulation of the reward function contributes to the learning efficiency. FIG. 9 further shows the average episode rewards computed over a 20-episode period.

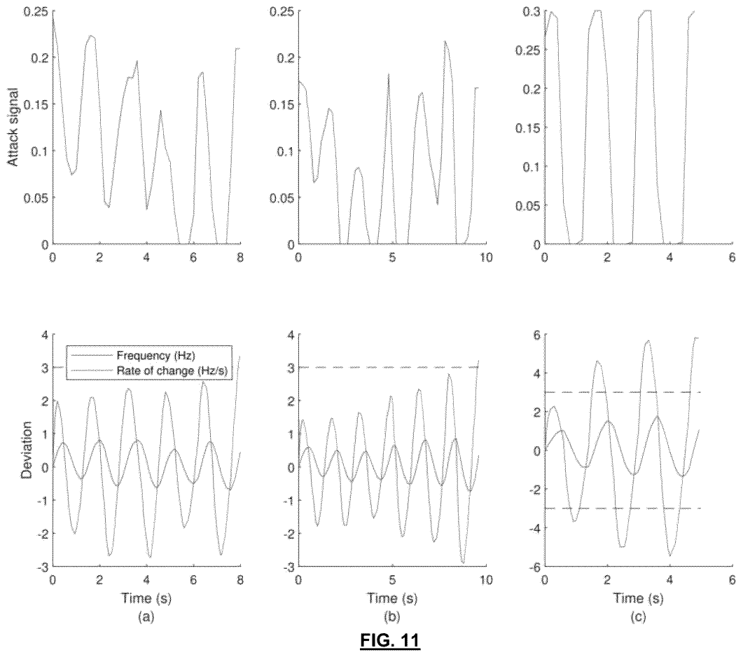

FIGS. 10 and 11 show a variety of frequency measurement corruption and load switching attacks, respectively, collected during RL training that destabilized the LFC model. Although these attacks are generally not optimal (e.g., in terms of time-to-failure), they are still able to trigger protection relays and therefore warrant attention.

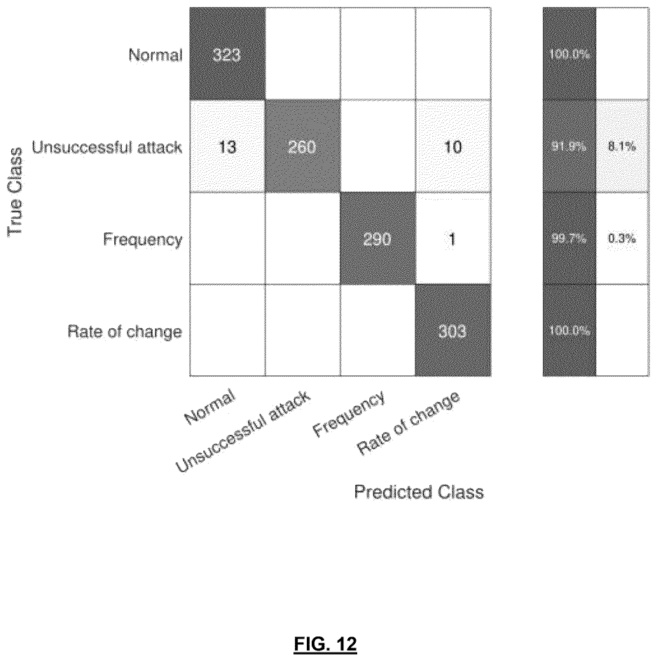

4000 records were gathered in the dataset and allocated 15% and 30% of the data for validation and testing, respectively. The attack detectors “Supervised-1” and “Supervised-2” achieved remarkable accuracies of 98% and 99.1%, respectively. Considering its comparatively lower complexity while still delivering commendable performance, the “Supervised-1” detector can be referred to as the representative supervised attack detector. To gain deeper understanding of the “Supervised-1” detector's performance, its corresponding confusion matrix is illustrated in FIG. 12. This visualization offers comprehensive insights into the detector's classification outcomes. FIG. 11 shows different aggregate load switching attacks against MG1. The compromised load capacity load is 0.3 pu. The attack signal in the top figure is the amount of load that is switched off. FIG. 12 shows supervised attack detector (Supervised-1) confusion matrix. The attack detector has a classification accuracy of 98%.

The neural network architecture for the supervised attack detector in the example experiment is shown in Table 3.

TABLE 3

| | |
|---|---|
| Supervised-1 | Supervised-2 |

| Layer | # of units | Layer | # of units |
|---|---|---|---|
| Sequence input | (Δe, Δ\hat{ω}) | Sequence input | (Δe, Δ\hat{ω}) |
| LSTM | 60 | LSTM | 55 |
| Dropout (10%) | | Dropout (10%) | |
| Fully-connected | 4 | LSTM | 45 |
| Softmax | 4 (c ∈ [symbol] ) | Dropout (20%) | |
| Sequence input | (Δe, Δ\hat{ω}) | LSTM | 40 |
| | | Dropout (10%) | |
| | | Fully-connected | 4 |
| | | Softmax | 4 (c ∈ [symbol] ) |
| Accuracy | 98% | Accuracy | 99.1% |

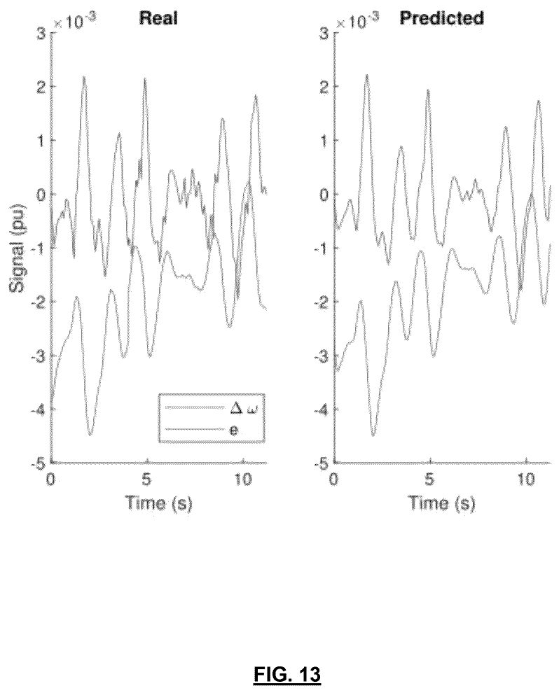

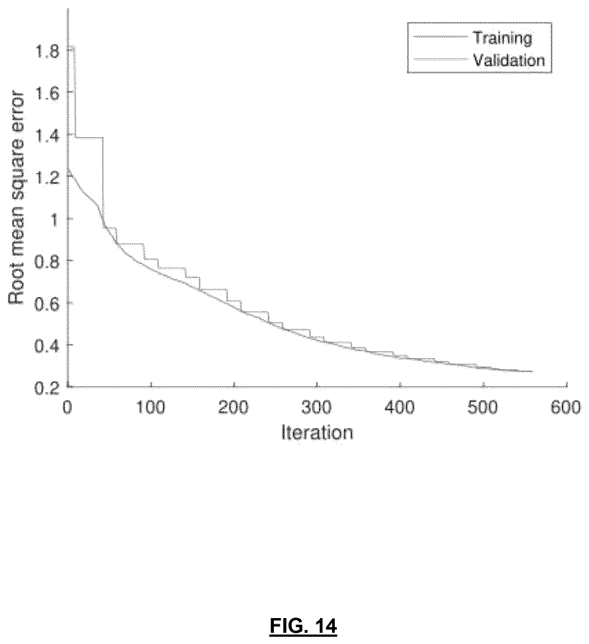

FIG. 13 demonstrates the reconstruction of the trained autoencoder for unsupervised anomaly detection. The left plot shows a portion of control signal and frequency measurement collected during normal operation. The right plot shows the autoencoder's reconstruction of the data. By learning the patterns of data during normal operation, the autoencoder is able to reconstruct the data with low error. FIG. 14 shows the autoencoder's reconstruction error during training. The reconstruction error, evaluated on the validation set, reaches a value of 0.29 in the final epoch. To establish a classification threshold for distinguishing between normal and anomalous behavior, an error threshold of 0.4 was selected. Remarkably, employing this threshold resulted in a 100% accuracy when categorizing instances as either normal or anomalous. Note that the test and validation sets utilized for computing the reconstruction error and establishing the classification threshold for the anomaly detector were identical to the sets employed in evaluating the accuracy of the supervised detectors to ensure a fair and consistent basis for comparison.

The neural network architecture for the unsupervised anomaly detector in the example experiment is shown in Table 4.

TABLE 4
Unsupervised

| Layer | # of units |
|---|---|
| Sequence input | (Δe, Δ\hat{ω}) |
| BiLSTM (w/ normalization) | 8 |
| ReLU | |
| BiLSTM (w/ normalization) | 2 |
| ReLU | |
| BiLSTM (w/ normalization) | 8 |
| ReLU | |
| Sequence output | |

When comparing the unsupervised anomaly detector's accuracy to that of the supervised attack detector in classifying normal and anomalous (comprising successful and unsuccessful attacks) operation, the detectors are comparable; at 100% and 98.9%, respectively. If, however, their accuracy is compared in classifying behavior preceding relay triggering (comprising successful attacks) and behavior that is not (comprising normal operation and unsuccessful attacks), the anomaly detector's accuracy is 76.4% compared to 99.2%. This echoes a major drawback of unsupervised methods, which is their high false alarm rate for safe anomalous events that are difficult to exhaustively include in their training data, even when these events do not have any impact on the system.

FIG. 13 illustrates an autoencoder data reconstruction on normal operation data. The high reconstruction similarity can be observed when the input data (left) is similar to the training data of the autoencoder. FIG. 14 shows root mean square (reconstruction) error of the unsupervised autoencoder-based anomaly detector during training.

The example experiments demonstrate the application of RL in compromising LFC. From an offensive perspective, an attacker can utilize RL actions in an FDI attack or embed the learned RL policy as malicious software. The RL agent offers a simple, fast, flexible, and adaptive approach to cyber offense, enabling it to adapt its actions to target different systems without the need for prior reconnaissance or exact models of the targeted systems. This emphasizes the need to employ RL defensively to proactively identify and collect attack strategies before system vulnerabilities are exploited.

On the defensive side, attackers can be modelled through the design of the RL agent involving two steps: (1) defining attack goals, through the formulation of the reward function, that specify the impact and consequences of the attack, which the system operator aims to prevent and anticipates that attackers would seek to achieve, and (2) identifying the access points that the system anticipates attackers may exploit by leveraging cyber vulnerabilities, as manifested in the agent's actions and observations. The attack goals and access points can be generally anticipated based on system knowledge and do not necessitate any specific knowledge of the attacker. However, the attack strategies that enable the attacker to achieve their goals are more challenging to anticipate or ascertain. The present embodiments provide an approach to generate a large dataset comprising such attack strategies. As demonstrated through the use of attack detectors, this dataset proves valuable for the development and testing of defenses. RL can further generate additional strategies by iteratively exploring various attacker goals and attack points, thereby enhancing the overall comprehensiveness of the defense strategies.

The example experiments illustrate that the system 50 can be used to synthesize multiple attacks against a system during the RL training. In an example, the RL training can be performed on an offline system model. Simulations can reveal vulnerabilities that need to be patched before deployment. Additionally, preceding every system change or upgrade, RL training can reveal vulnerabilities before a cyberattacker capitalizes on them.

The example experiments also illustrate that the system 50 can be used to validate defense strategies. After a vulnerability is identified in training, defense methods including upgrading control algorithms (physical), upgrading code security (computational), or adding channel redundancy (communication-based) can be designed and incorporated into the offline model. If the defense method passes the previously successful logged attacks and further RL training without any system failures, then the defense can be deployed to enhance system security.

The example experiments also illustrate that the system 50 can be used such that a single RL agent can execute successful attacks against different systems. This provides an opportunity to collect an ‘arsenal’ of RL agents and provide them for system owner-operators to automatically test vulnerabilities. After modelling their system, the owner-operator can retrieve the RL agents from repositories and have each RL agent check for a specific system vulnerability.

In some cases of the present embodiments, an integrated approach can be used to detect attacks by leveraging the unique strengths of both the anomaly detector and the attack detector. The anomaly detector excels in identifying normal behavior and boasts a lower computational complexity, while the attack detector offers greater sensitivity in detecting attack behavior warranting immediate attention.

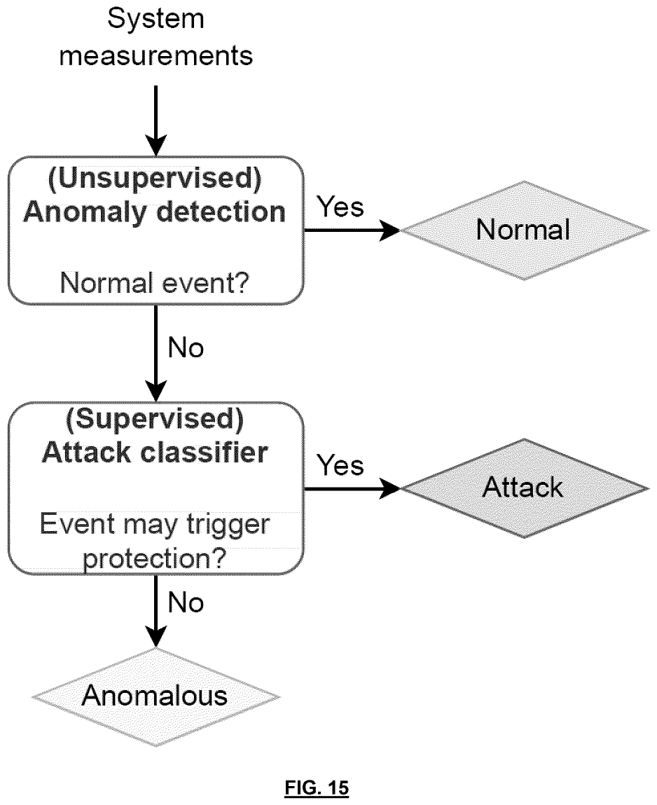

FIG. 15 illustrates a block diagram of an example approach for implementation of the integrated approach. Instances classified as normal by the anomaly detector are accepted without further scrutiny. Conversely, instances deemed abnormal by the anomaly detector are subjected to evaluation by the attack detector to determine whether they are indicative of an attack. This integrated approach effectively reduces the computational effort required to continuously classify frequent normal events, as the anomaly detector is considerably smaller in size. Instead, the attack detector is utilized to selectively filter anomalous events, identifying those that demand urgent attention and distinguishing them from anomalous behavior that May not be of immediate concern. This approach can be implemented within the control stations of generation facilities and microgrid control centers to categorize grid events and detect attacks.

Advantageously, the present embodiments can proactively identify grid vulnerabilities and attack strategies to anticipate attacks and patch grid weaknesses before they are exploited. In particular cases, the system 50 uses deep (DDPG) RL agents to execute FDI and load switching attacks against LFC. The RL-generated attacks directly induce protection relay tripping and generation loss, which can subsequently lead to grid instability and blackout. Training of the RL agent provides valuable insight into attacker resources and strategies, including specifying attack and threat models and generating attack datasets. The attack datasets can be used defensively to inform, evaluate and develop defense strategies. The system 50, in some cases, uses an LSTM-based supervised-learning model to classify and detect attacks for anomaly detection. The supervised attack detector achieves substantial accuracy (98.9%) when classifying normal and anomalous operation and the supervised attack detector classifies events with high accuracy (99.2%). In embodiments of the present disclosure, an integrated attack detector is provided that makes use of the strengths of both anomaly detection and supervised attack detection to improve attack detection accuracy while reducing false detection and computational effort. The present embodiments advantageously provide a more targeted and robust evaluation compared to traditional verification methods that rely on random or general template attacks. By leveraging RL, the effectiveness and resilience of defense strategies can be assessed in the face of sophisticated and tailored attack scenarios.

The present embodiments, through RL, can further be used to synthesize attack data. Attack synthesis can enable precise responses to attacks according to their severity and can provide real-time risk metrics assessing system vulnerability.

Generally, implementing anomaly detection can pose significant challenges as, in many cases, anomaly detectors often generate a high volume of false alarms. A false alarm refers to an incident where normal or benign events are incorrectly identified as malicious or harmful. In the context of anomaly detection, this involves incorrectly flagging the presence of a threat or an attack when none exists. Further, even when a threat exists, attacks vary in severity, requiring distinct responses. While urgency is crucial for high-severity attacks, a similar response to low-severity situations may be counter-productive or disruptive to ICS security. For example, attackers can exploit the high sensitivity of anomaly detectors to overwhelm security teams with event logs, redirecting valuable resources into unnecessary investigations and obscuring real cyberattacks, leading to either undetected attacks or the distraction of security teams. Being able to detect, classify, and describe anomalies based on their severity is imperative for effective and reliable defenses. Such detection allows for precise and proportionate responses to anomalies: distinguishing threats from benign events, ensuring prompt detection and appropriate reaction, and prioritizing responses based on severity. Achieving precision in detecting and responding to anomalies, however, requires data across a broad spectrum of severity.

The scarcity of anomaly data, coupled with the risks associated with overlooking potential threats to ICS, means it is particularly advantageous to synthetically generate anomalous grid events with varying severity levels. Having a broader range of anomalous events enables defenses that, besides accurately detecting anomalies caused by attacks, can precisely distinguish anomalies according to severity. In this way, synthesizing data representing anomalous grid events with varying severity levels can provide the data needed to train more comprehensive models that enable a more tailored threat response. Accordingly, embodiments of the present disclosure use of optimization and RL to generate synthetic anomalous grid data and demonstrate benefits of attack synthesis in responding to anomalies.

The following generally illustrates synthesizing attack data for cyber-physical attacks directed at in microgrids (MG); however, the following can be applied to any suitable type of attack on a grid. In this case, MG networks are highly susceptibility to cyberattacks and their low inertia makes them especially vulnerability to cyber-physical attacks targeting LFC. Generally, LFC plays a crucial role in maintaining power system stability by regulating system frequency, thus making it a prime target of cyber-physical attacks. Further, LFC involves wide-area control functions that rely on potentially vulnerable open communication infrastructure for receiving frequency measurements from different areas, obtaining tie-line power flow data, and dispatching automatic generation control (AGC) to participating generators.

It has been shown that attacks, including false data injection, denial of service, and load altering, against LFC can lead to frequency excursions, triggering protection relays and resulting in generation loss and power imbalance. Furthermore, these attacks can negatively impact automatic generation control, electricity market operation, cause load shedding, power swinging between areas, or force cascading failure.

Effective defense includes accurately and promptly detecting malicious attacks, while precisely distinguishing them from benign anomalous grid events. In the case of LFC, achieving precision is challenging because various factors affecting frequency lead to diverse anomalies. The continuous integration of intermittent generation and diverse dynamic loads further complicates distinguishing anomalous grid events from cyberattacks. Grid events manifest as temporal data that has influence over the power system. Taking the instance of load changes, a grid event unfolds as a time-series depicting sequential change in the system's load over some period of time. Within this context, the power system load normally undergoes typical changes that pose no risk to the grid. Atypical load changes can be categorized either as benign anomalous events or, in the context of a cyberattack, as anomalous events strategically crafted to inflict harm upon the grid.

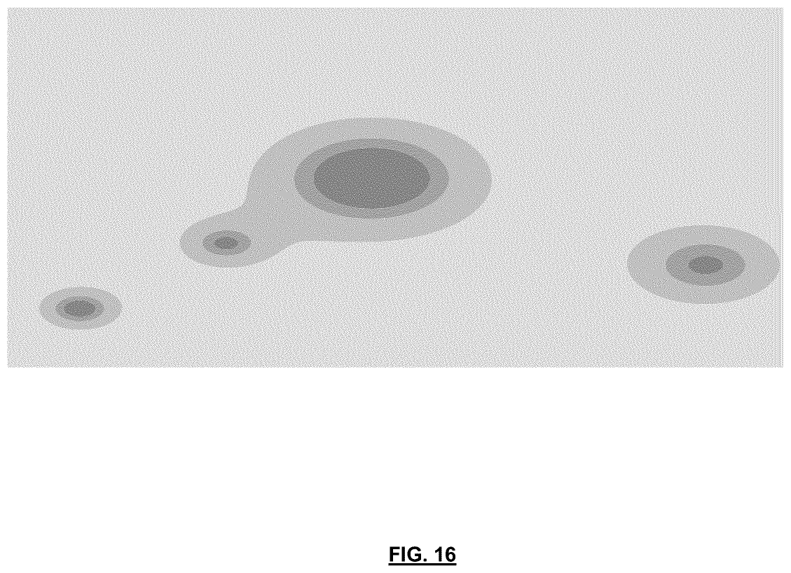

In FIG. 16, illustrated is an abstract visualization of grid events. Each point plotted in the plane of FIG. 16 symbolizes a time-series representing a grid event (independent variable). The tones assigned to these points illustrate the severity of the grid events' impact on the system (dependent variable). This severity can be quantified in terms of diminished power quality, grid stability indices, risk metrics, or otherwise. The darker tones within the visualization serve to represent grid events with higher potential for causing harm. Particularly, the dark centers within the visualization indicate events that may have been instigated by strategic attacks, carrying the potential for immediate grid instability. The gradient thus aids in intuitively grasping the varying degrees of severity associated with different grid events. In an example, darker tones indicate larger RoCoF fluctuations.

In practical applications, the space illustrated in FIG. 16 serves as a tool that enables grid operators to foresee the impact of grid events and plan appropriate responses to threats. Responses can be designated for rapid threat mitigation upon identifying grid events in the dark zones. Although events in the mid-darkness zones remain severe, they may afford grid operators the time needed to evaluate and manually dispatch response. Thus, distinguishing between events in the dark and mid-dark zones allows operators to respond to threats with a level commensurate with the associated risks. The lighter zones represent benign grid events that should not trigger any threat response.

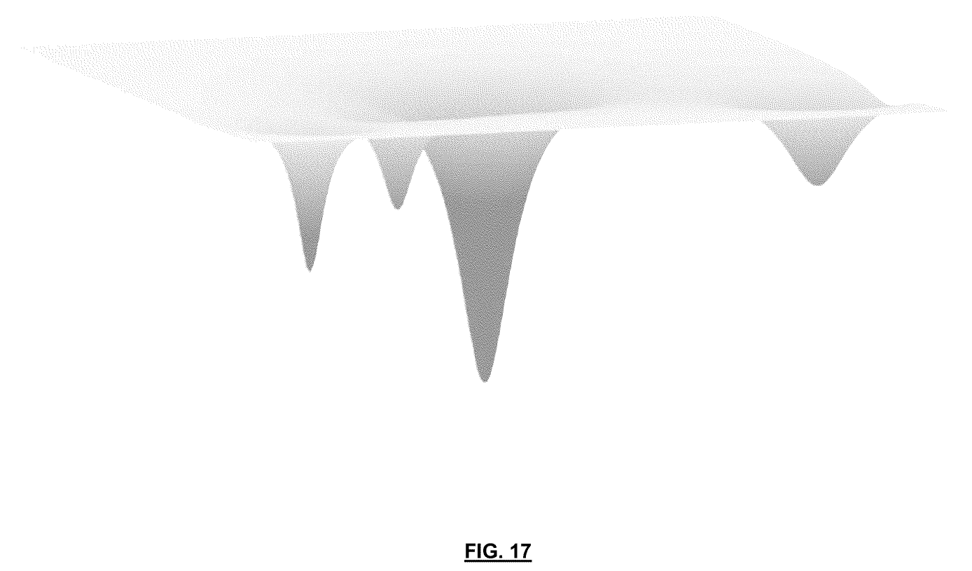

The present embodiments provide a systematic approach to explore the depicted space to decipher the typically complex, high-dimensional function mapping ICS grid events to their severity; where FIG. 17 abstractly visualizes this function. The goal is to use this space as a preliminary tool for generating grid event data to develop precise and accurate methods for threat detection and classification. In this way, a well-defined optimization function over the attack space can guide an agent in systematically exploring the space.

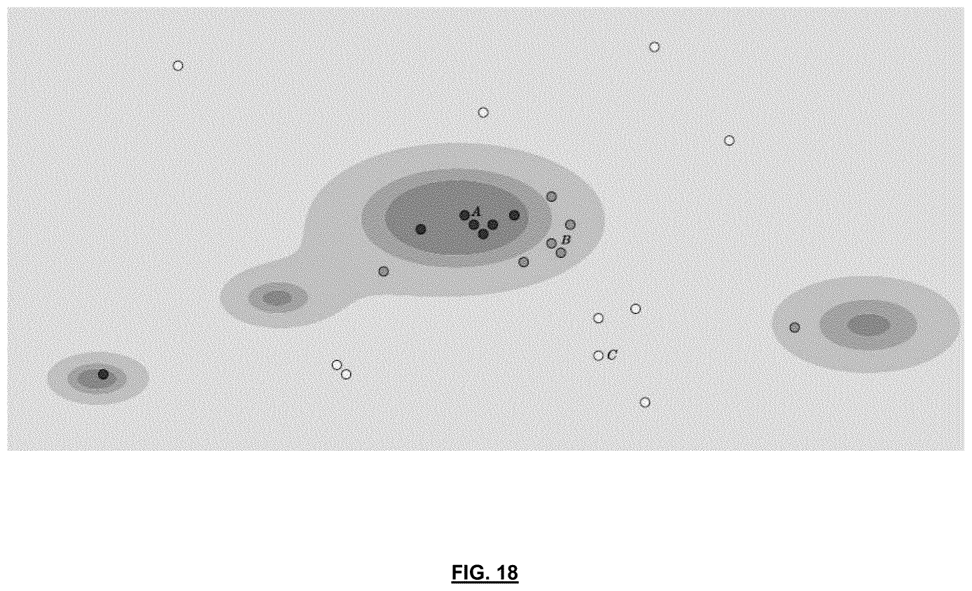

Instead of random exploration of the space, the system 50 adopts optimization and RL for systematic exploration, progressively directing grid event sampling towards the dark zones representing critical grid events. As the optimization and RL techniques sample grid events during the improvement of their objective functions, the sampled data is collected and categorized based on severity. FIG. 18 is an example illustrating sampled events within each zone, categorizing them as high-, medium-, or low-severity events based on tone. Synthetic attack generation thus can involve exploring points in the space and labelling them according to severity. A classifier can, subsequently, learn a distribution for each category in order to distinguish the different categories.

Sampling within the dark zone, specifically, generates data representative of the grid events that a malicious cyber attacker might impose to disrupt the grid. Consequently, this exploration of the space facilitates the synthesis of attack data. Advantageously, this synthetic attack data can aid in understanding system vulnerabilities and potential attacker strategies. Additionally, by utilizing the collected data, a classifier can learn distributions for each label, establishing a means for real-time threat detection and classification. Hence, the process of sampling the space contributes to the generation of categorical data, which can be employed to train models for classifying threats in real time.

A dynamic model of the power system that is to be protected serves as the basis for determining an optimization model and representing the RL environment. The dynamic model can be expressed generally as:

$$\dot{x} = f ( x , u ) \qquad ( 19 )$$

For simplicity and without loss of generality, a discrete linear LFC model can be used based on a swing equation, however, any suitable model can be used. Linear LFC models are widely accepted and utilized for cyber-physical attack analysis and power system LFC studies because they facilitate faster optimization and RL convergence. Additionally, they allow for systematic tractable study of the system and attacks. For example, to determine a power system's eigenvalues to assess the physical vulnerabilities targeted by synthetic attacks. In should be noted, that the present embodiments can be extended to non-linear systems expressed by Equation (19) by utilizing non-linear optimization techniques for exploring the attack space. The RL approach is consistent, with the RL environment adapting to express the characteristics of the non-linear system.

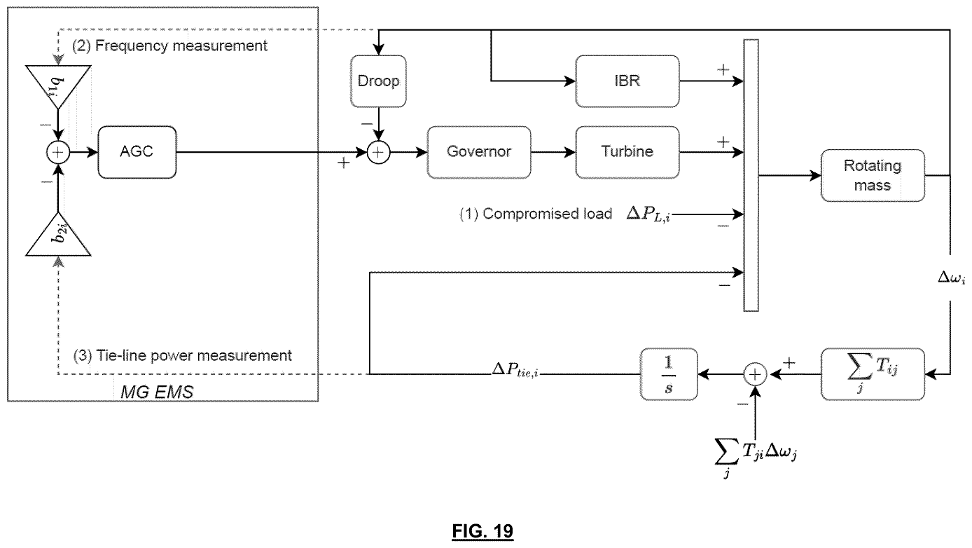

FIG. 19 illustrates an exemplary block diagram for a general area i of the LFC model. It consists of an AGC-participating synchronous generation, modelled by governor, turbine, and rotating mass blocks, with governor-droop local control. Inverter-based resources (IBR) can provide support in terms of virtual inertia emulation or active power droop control. Considering a timescale of Tₛ seconds for the grid events, where the disturbances affect the system every Tₛ seconds, the dynamical model can be expressed in terms of the discrete state space model in Equation (20):

$${x}_{t + {T}_{s}} = {A}_{D} {x}_{t} + {B}_{D} {u}_{t} \qquad ( 20 )$$

$${y}_{t + {T}_{s}} = {C}_{D} {x}_{t + {T}_{s}}$$

The state vector x in Equation (20) includes internal states of generators, area frequencies and their rate of change, and tie-line power flows. The input u consists of the disturbances that cyberattackers may inject into the power system. Potential disturbances are illustrated in red in FIG. 19. The output vector extracts the risk metric used in the optimization's objective function formulation or the RL agent's reward function. A load change can be considered as the disturbance (or grid event) and the RoCoF as the risk metric. Hence, u=[ΔP_{L,i}]^{i=1, 2, . . . , N} where i denotes the area, ΔP_{L,i} is the load change in area i, and N is the number of areas. Vector y consists of the RoCoF in all areas. Note that the state at time t+nTₛ can be expressed as:

$${x}_{t + {nT}_{s}} = {A}_{D}^{n} {x}_{t} + {A}_{D}^{n - 1} {B}_{D} {u}_{t} + {A}_{D}^{n - 2} {B}_{D} {u}_{t + {T}_{s}} + … + {A}_{D} {B}_{D} {u}_{t + ( n - 2 ) {T}_{s}} + {B}_{D} {u}_{t + ( n - 1 ) {T}_{s}} \qquad ( 21 )$$

In a particular case of the present embodiments, acquiring attack data through optimization involves solving the optimization problem of Equation (22); which is convex with the use of the linear discrete state-space system. In formulating the objective function in Equation (22), the most optimal attack aims to maximize the [symbol] 2-norm of the RoCoF across all areas throughout the attack duration, which spans nTₛ seconds. The system 50 navigates the gradient to find the most optimal attack with respect to the risk metric. In each iteration, the attack vector U is collected as a sequential data-point and labeled based on its impact on the RoCoF values of the power system. Generally, such labels are subjective and can have any suitable value.

$${U}^{*} = {arg min}_{U} - {‖ C ( {Ax}_{t} + BU ) ‖}_{2} \qquad ( 22 )$$

$$subjectto \underline{U} 1 \leq U \leq \overline{U} 1$$

here the matrices expressed in the objective function:

$$X = {Ax}_{t} + B \qquad ( 23 )$$

$$Y = CX$$

can be expanded into:

$$[ \begin{matrix}{x}_{t + {T}_{s}} \\ {x}_{t + 2 {T}_{s}} \\ ⋮ \\ {x}_{t + {nT}_{s}}\end{matrix} ] = [ \begin{matrix}{A}_{D} \\ {A}_{D}^{2} \\ ⋮ \\ {A}_{D}^{n}\end{matrix} ] {x}_{t} + [ \begin{matrix}{B}_{D} & 0 & ⋯ & 0 \\ {A}_{D} {B}_{D} & {B}_{D} & ⋯ & 0 \\ ⋮ & ⋮ & ⋱ & ⋮ \\ {A}_{D}^{n - 1} {B}_{D} & {A}_{D}^{n - 2} {B}_{D} & ⋯ & {B}_{D}\end{matrix} ] [ \begin{matrix}{u}_{t} \\ {u}_{t + {T}_{s}} \\ ⋮ \\ {u}_{t + ( n - 1 ) {T}_{s}}\end{matrix} ] \qquad ( 24 )$$

$$[ \begin{matrix}{y}_{t + {T}_{s}} \\ {y}_{t + 2 {T}_{s}} \\ ⋮ \\ {y}_{t + {nT}_{s}}\end{matrix} ] = [ \begin{matrix}{C}_{D} & 0 & ⋯ & 0 \\ 0 & {C}_{D} & ⋯ & 0 \\ ⋮ & ⋮ & ⋱ & ⋮ \\ 0 & 0 & ⋯ & {C}_{D}\end{matrix} ] [ \begin{matrix}{x}_{t + {T}_{s}} \\ {x}_{t + 2 {T}_{s}} \\ ⋮ \\ {x}_{t + {nT}_{s}}\end{matrix} ] \qquad ( 25 )$$

The constraints denoted by U and Ū set boundaries on the load change. For instance, these constraints can represent the limits on the load that the attacker can add or remove from the power system during an attack. In terms of formulating the optimization model for defense, the defender (system operator or security teams) can use these constraints to specify the uncertain portion of the system load that can introduce uncertainty that needs to be distinguished from malicious attacks, or vulnerable portion that could be compromised in an attack. For the latter, this modeling can help understand the potential impacts of intelligent attacks that exploit vulnerable loads.

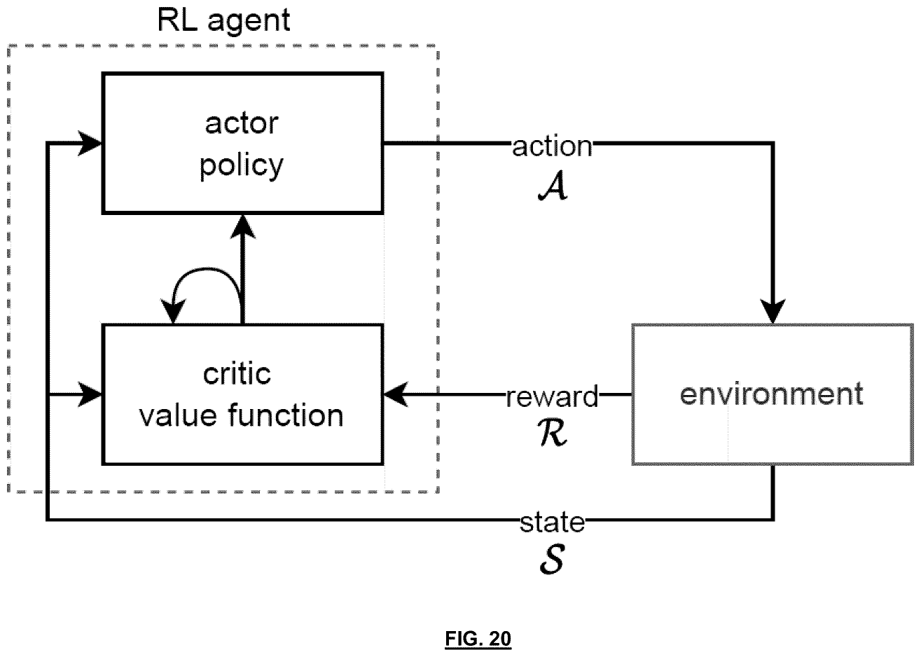

FIG. 20 illustrates the RL agent, composed of actor and critic neural networks, interacting with an environment that emulates the power system. The agent applies actions [symbol] into the system, observes some system states [symbol] , and, based on the impact of the attacks, receives a reward [symbol] . The reward function is analogous to the optimization objective function, guiding the agent to take actions that inflict more harm.

The actor network defines the action policy, generating the disturbances that the RL agent injects into the power system. The critic neural network produces a Q-value Q( [symbol] ; [symbol] ) estimating the cumulative reward the agent can expect from injecting disturbances into the power system. The RL agent alternates between exploitative and explorative actions, exploiting to maximize the Q-value given the current power system observation and exploring by introducing randomness to potentially discover better strategies.

The RL agent learns in episodes, where each episode simulates the system experiencing disturbances that are injected by the RL agent for a duration of nTₛ seconds. These episodes are analogous to the iterations in the optimization problem. Similar to the optimization model, the agent injects a disturbance into the system every Tₛ seconds during these episodes. Each action [symbol] ₜ at time t expresses the input vector uₜ for the system (refer to Equation (2)). The attack space, depicting the possible values of actions [symbol] , is constrained within U and Ū for direct comparison with the optimization model. Similarly, collecting attacks generated by the RL agent includes recording its attack actions in a vector U and labeling them based on their effects on the RoCoF.

In a particular case, a Proximal Policy Optimization (PPO) RL agent can be used due to its compatibility with continuous observations and actions, however, any suitable RL agent can be used. The reward function is formulated similarly to the optimization model, where the reward is proportional to the [symbol] 2-norm of the RoCoF in the power system areas. Specifically, the reward function is:

$${ℛ}_{t} = {a}_{1} {‖ {y}_{t} ‖}_{2} + {a}_{2} \{ exceedRoCoFthreshold \} \qquad ( 26 )$$

The first term provides soft rewards to the RL agent based on the RoCoF, while the second term offers a high discrete reward when the agent forces the RoCoF in any area to exceed a certain threshold for the purpose of accelerating agent learning. This threshold can be selected to match the system's RoCoF protection relay limits. For example, a RoCoF threshold of 3 Hz/s can be used in accordance with IEEE Standard 1547-2018 Category III RoCoF limits. The episode terminates prematurely if the RoCoF exceeds its threshold. Coefficients a₁ and a₂ scale the terms in the reward function.

In an example, the neural network architectures and hyperparameters of the RL agent can be as follows:
Sequence Input Layer (#Features=2)
Convolution 1D-Layer (Filter size=25, #Filters=32)
ReLU Layer
Layer Normalization Layer
Convolution 1D-Layer (Filter size=5, #Filters=64)
ReLU Layer
Layer Normalization Layer
Global Average Pooling 1D-Layer
Fully Connected Layer (#Units=3)
Softmax Layer
Classification Layer
Mini-batch size=48

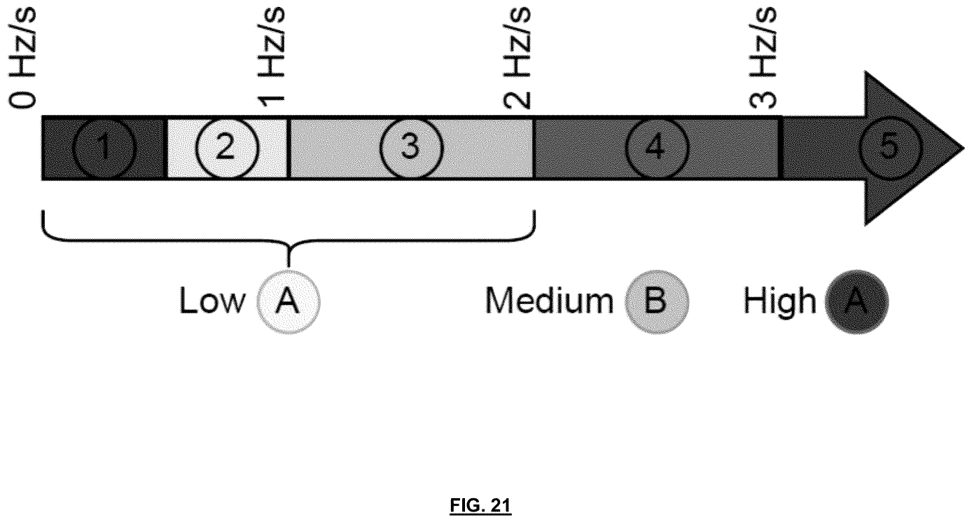

Using the RoCoF as the risk metric, the system 50 can categorize risk per the RoCoF ranges illustrated in FIG. 21. The ranges correspond to different RoCoF levels arising from grid disturbances. Low-granular labels (low-, medium-, and high-severity) are used for classifying grid events. The darkness of these labels align with those discussed with respect to FIGS. 16 to 18. Low-severity correspond to events with RoCoF below 2 Hz/s, medium tones represent RoCoF between 2 and 3 Hz/s, and high-severity events exceed the RoCoF threshold of 3 Hz/s.

Severity indicates the urgency of responding to an event. Low-severity events May require minimal attention, potentially considered benign. This category likely encompasses most false alarms hindering the adoption of anomaly detection. Medium-severity events deserve attention, affording a security team's time for response evaluation. High-severity events demand an immediate response, potentially requiring an autonomous response to prevent generation loss.

We employ a CNN-based classifier, anticipating that CNNs can effectively analyze event sequences, learning distinctive patterns and features that differentiate them. We choose load power as the input sequence to the classifier for the following reason: load power undergoes instantaneous changes whereas the frequency responds per relatively slower system dynamics following these changes. Therefore, utilizing measured load for attack detection can enable in-advance reaction before any implications of the frequency fluctuation.

For each input sequence in the low- and medium-severity labels, the system 50 can trim the sequence at the time when the RoCoF peaks. For high-severity labels, the system 50 can trim the sequence even earlier: T_{adv} seconds before the RoCoF exceeds 3 Hz/s. This anticipatory trimming is to train the classifier to detect high-severity events even earlier to enable timely response. In a particular case, T_{adv}=1 second can be used. The system 50 can reshape the input sequence to the classifier, comprising U∈ [symbol] ^{Nn×1}, to an N-dimensional matrix

$${[ {U}_{i}^{T} ]}^{i = 1 , 2 , … , N} ∈ {ℝ}^{N \times n} .$$

Each row i corresponds to the load change in area i, and each column represents the load changes across all areas at time-step t. Thus, the classifier can be a function, whereby:

$$f ( [ {U}_{i}^{T} ] ; θ ) \text{:} {ℝ}^{N \times n} \to 𝒞 ∈ \{ Low , Medium , High \} \qquad ( 27 )$$

The above function maps the change in load power across the interconnected system to a categorical risk metric of the anticipated system state. Here, θ denotes the learnable parameters of the neural network. An example of a neural network architecture and hyperparameters of the classifier are provided in Table 5:

TABLE 5

| Block | Area 1 | Area 2 |
|---|---|---|
| Governor | $\frac{1}{0.08 s + 1}$ | $\frac{1}{0.1 s + 1}$ |
| Turbine | $\frac{1}{0.45 s + 1}$ | $\frac{1}{0.48 s + 1}$ |
| Rotating mass | $\frac{1}{6 s + 0.03}$ | $\frac{1}{4.5 s + 0.02}$ |
| AGC | $\frac{3}{s}$ | $\frac{2.8}{s}$ |
| Droop | 40 | 35 |
| IBR | $\frac{- 10}{0.1 s + 1}$ | $\frac{- 8 s}{0.1 s + 1}$ |

In some cases, the above CNN-based classifier can be employed centrally, where it collects measurements of the load changes across the system over the previous nTₛ seconds and outputs a categorical description of the anticipated risk to the system's RoCoF due to these load changes. In high-severity events, the categorization from the CNN can dispatch pre-established autonomous responses to maintain system integrity.

The example experiments were further conducted on two interconnected microgrids (MG) operating in-isolation from a main grid. Each MG consisted of a 2.5 MVA diesel synchronous generator, a 2 MVA wind generator, and a 125 KW battery. Each MG was considered an area in the LFC model. For the experiments, Tₛ=0.2 seconds, nTₛ=20 seconds, N=2 areas, a₁=1, and a₂=20.

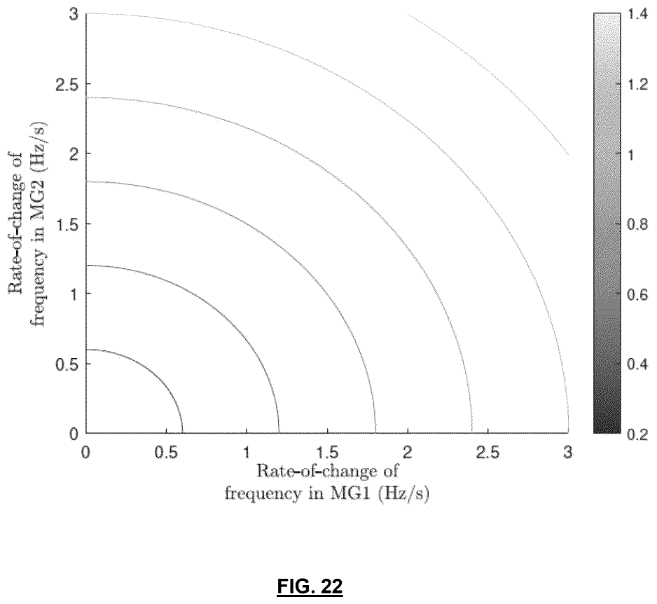

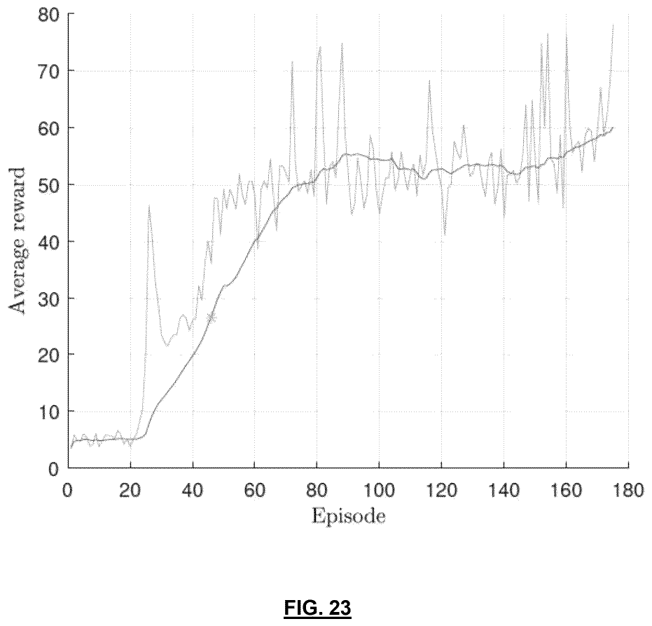

FIGS. 22 and 23 are illustrations of the soft reward term of the RL agent and the training progress of the agent. FIG. 22 shows an RL agent reward function. The reward increases with the RoCoF in the two interconnected MG systems. FIG. 23 shows the agent reward in each episode and the rewards averaged over 25 episodes. In FIG. 23, the rapid improvement of the rewards shows that the RL agent rapidly learns a policy of malicious strategic attacks.

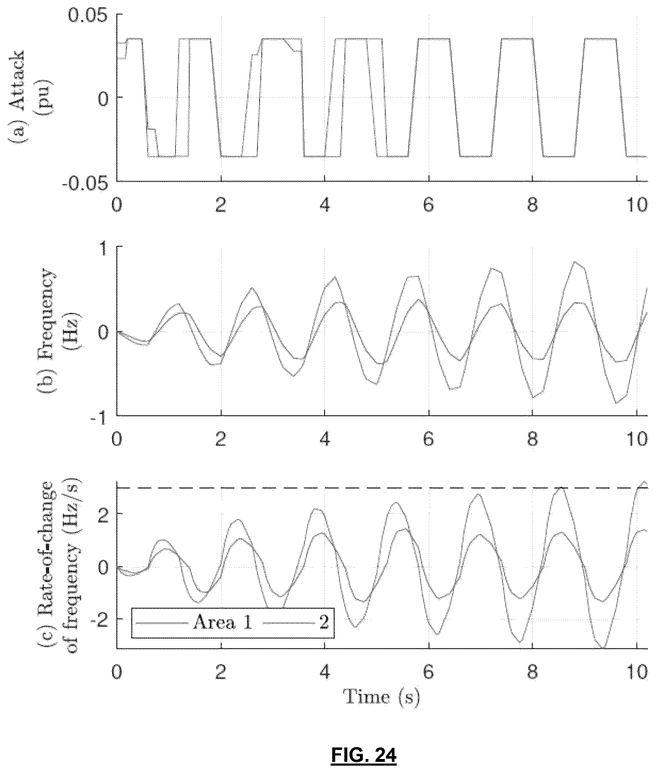

Such strategic attack is illustrated in FIG. 24 which illustrates the load change, resulting frequency fluctuation, and the RoCoF in the two MGs (denoted as Area 1 and Area 2 in the legend), respectively. The RoCoF steadily increases during the attack until it surpasses the protection threshold shown by horizontal dashed lines, leading to a loss of generation in Area 2. The simulation is halted at the time of generation loss to focus the attack's impact on the RoCoF.

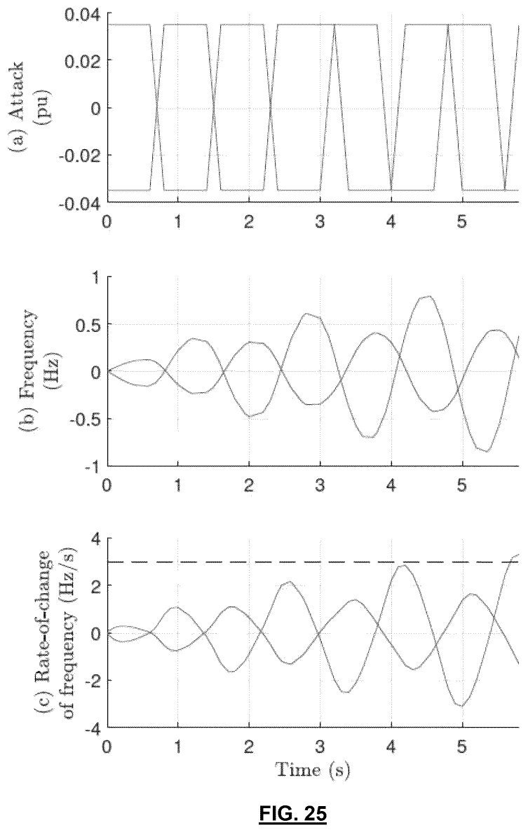

The optimization model yields the optimal attack presented in FIG. 25. In comparison, this attack is capable of triggering protection mechanisms more rapidly. This aligns with the expected outcome that optimization converges to the most optimal attack, resulting in a more aggressive attack on the system.

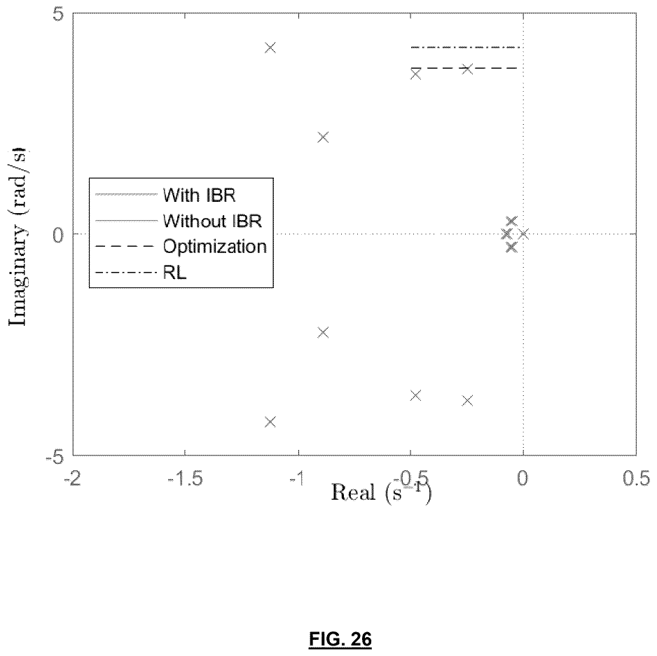

Upon further analysis, it can be seen that the dominant frequency in the attack obtained through the optimization model matches the frequency of an undamped eigenmode of the system. This alignment is evident in the zero-pole map depicted in FIG. 26, where the dashed line corresponds to the frequency of the optimization model attack, intersecting the eigenmode frequency at j3.7 rad/s. FIG. 26 shows a zero-pole map, where the optimization model generated attack yields precise attacks. Conversely, the RL agent injects an attack with a dominant frequency slightly above the eigenmode, leading to system failure but with a less optimal performance, requiring more time to harm the system.

Advantageously, as evidenced in the example experiments, RL identifies the vicinity of this eigenmode without prior knowledge of the power system. In contrast, the optimization model benefits from complete knowledge of the power system to converge to the specific eigenmode.

In some cases, attaining an exact system model is often highly infeasible for both attackers and system operators (defenders), where approximate grid models for planning and system studies are often employed. The example experiments also evaluated attack effectiveness when the power system deviated from the initial model used to train the RL agent and formulated the optimization model.

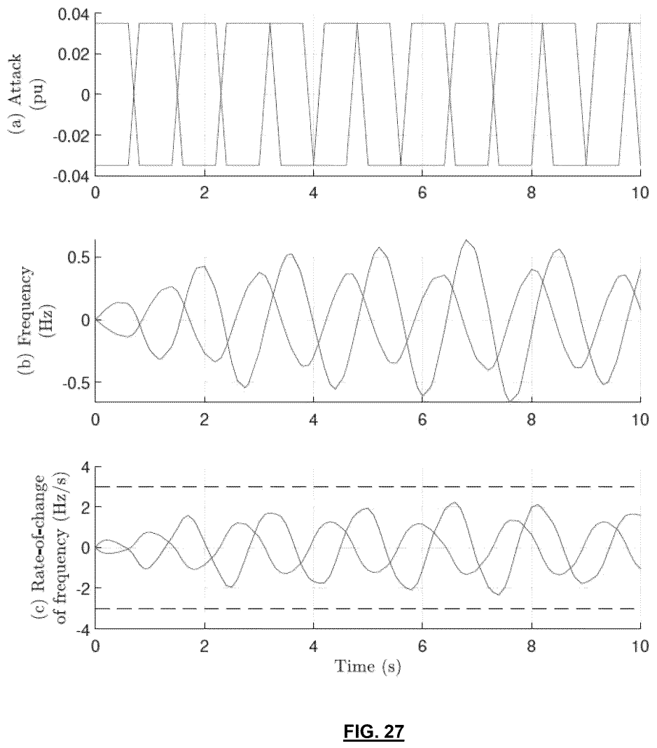

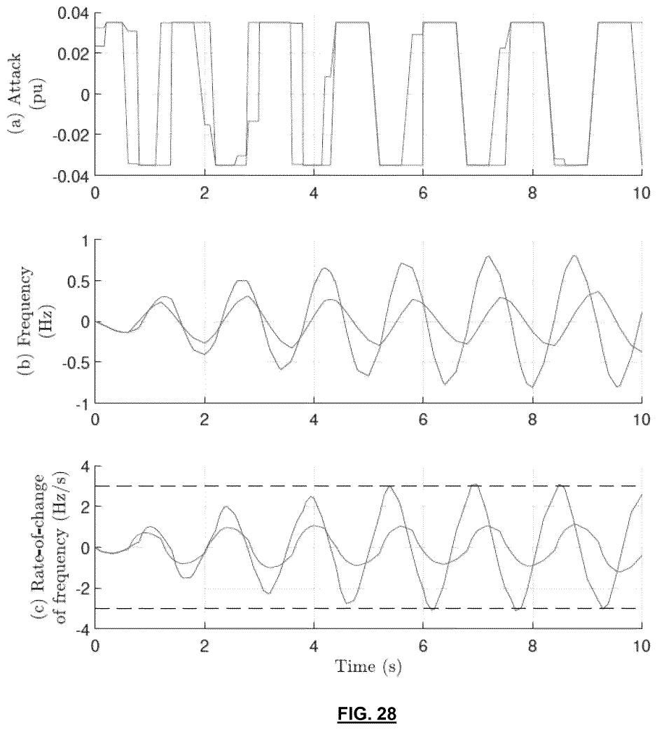

The optimization model generally generates an optimal attack as a static, fixed strategy. FIG. 27 replicates this optimal attack on the modified system showing a significant decline in effectiveness. The optimization model-generated attacks are very sensitive to model inaccuracies or changes. In contrast, FIG. 28 demonstrates how the RL-generated attack adapts to changes in the power system. Despite modifications to the power system, the RL agent-generated attack retains the ability to force the RoCoF beyond its threshold. In this way, the RL agent adjusts its attack to target various power systems without further training. FIG. 28 observes a frequency change from 0.673 Hz to 0.735 Hz between the initial and modified power system.

This result underscores a significant advantage of RL over optimization. While optimization may appear superior, following a well-defined gradient to an optimal attack, its efficacy heavily relies on an exact system model, which is often infeasible to obtain. Additionally, this highlights the potential risk of attackers employing RL in attack synthesis. An RL agent trained on a generic LFC model can effectively adapt in real-time to the attacked system characteristics without requiring prior specific knowledge of the system's physical dynamics.

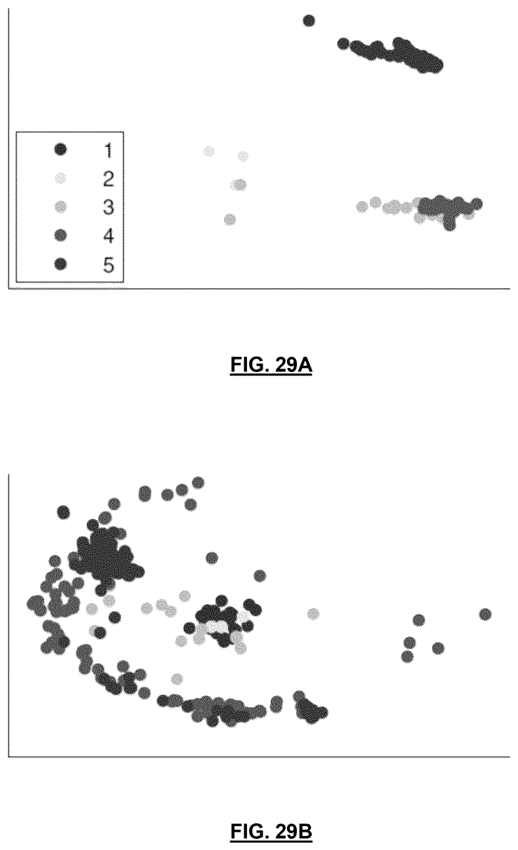

Examining the similarities between optimization model-generated and RL-generated sequences reveals distinct distributions. FIGS. 29A and 29B utilize t-distributed Stochastic Neighbor Embeddings (t-SNE) to visualize these sequences. t-SNE is a non-linear dimensionality reduction technique, allowing the visualization of high-dimensional data. Distances between points visualize dissimilarity, with proximity indicating similarity and increased distance indicating dissimilarity with high probability. The reduced representations of the sequences generated by the optimization model and the RL agent are plotted in FIGS. 29A and 29B, respectively. The axes in FIGS. 29A and 29B are the same and the values on the axes have been suppressed as they do not represent any information in themselves.

The sequence datasets can be used to provide ample training points for the classifier in order to compare classification performance using optimization and RL data, and to quantify any shortcomings in the generated data. For expanding the optimization dataset, a particle swarm with a size of 7 was run. Each particle started with a different random initialization, aiding in spreading out the data-points. Multiple iterations were run, each with varying limits on vulnerable load capacity, starting from 0.5% pu to 3.5% pu with 1% pu steps. This increased the representation of less severe attacks in the optimization model-generated dataset. For RL attacks, training was re-run with different random initializations of its neural networks until sufficient data is collected.

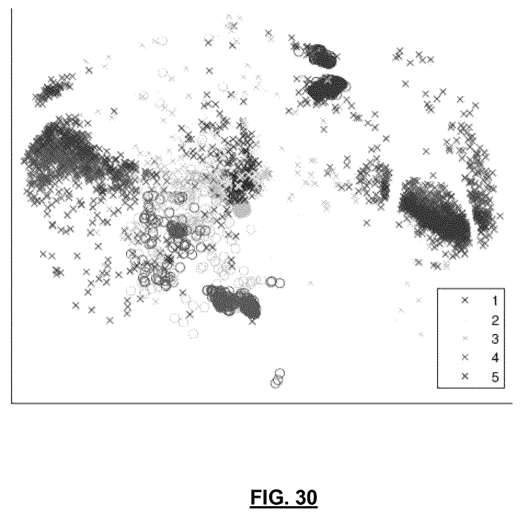

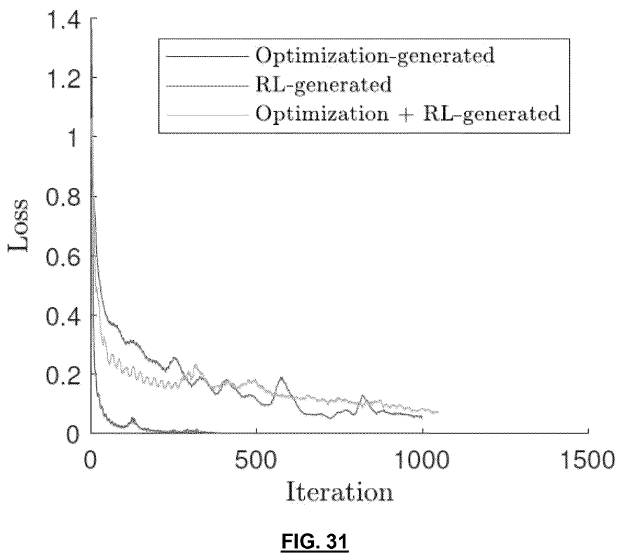

From each of the optimization model and RL experiments, a dataset of 1980 sequences was collected, split evenly among the three severity labels. The t-SNE plot of all optimization model-generated and RL-generated data-points is displayed in FIG. 30. A stratified split of 85%, 15%, and 15% is employed for training, testing, and validation, respectively. First, the CNN classifier is trained on the optimization model-generated data; called Classifier-1. Next, the same CNN classifier is re-initialized and trained on the RL-generated data; called Classifier-2. The training loss curves of the classifiers are presented in FIG. 31, demonstrating the classifiers' effectiveness in distinguishing events within their datasets based on their labels. Training loss of classifiers show that they learn how to distinguish between the training set data-points effectively.

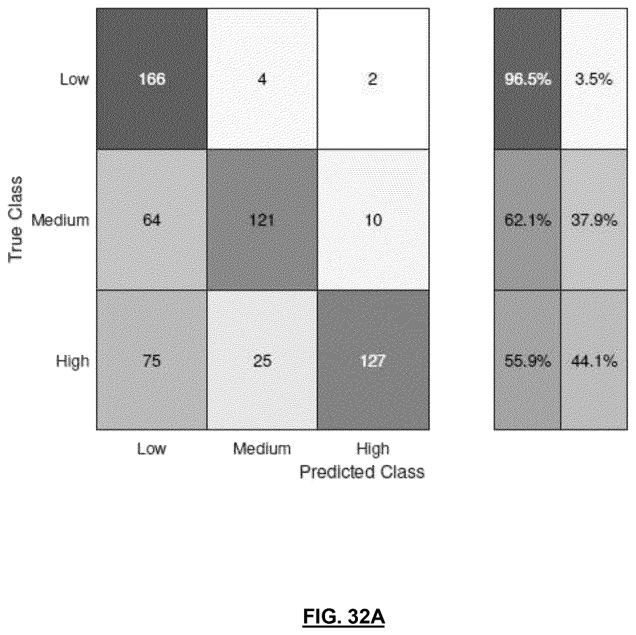

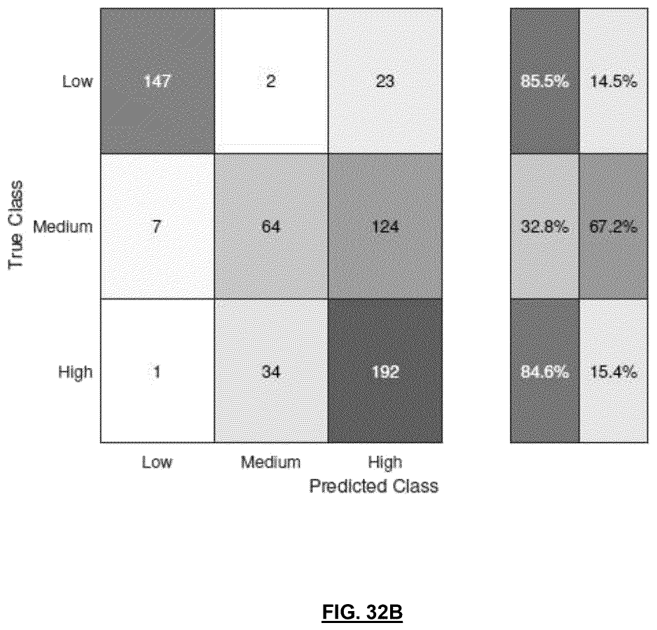

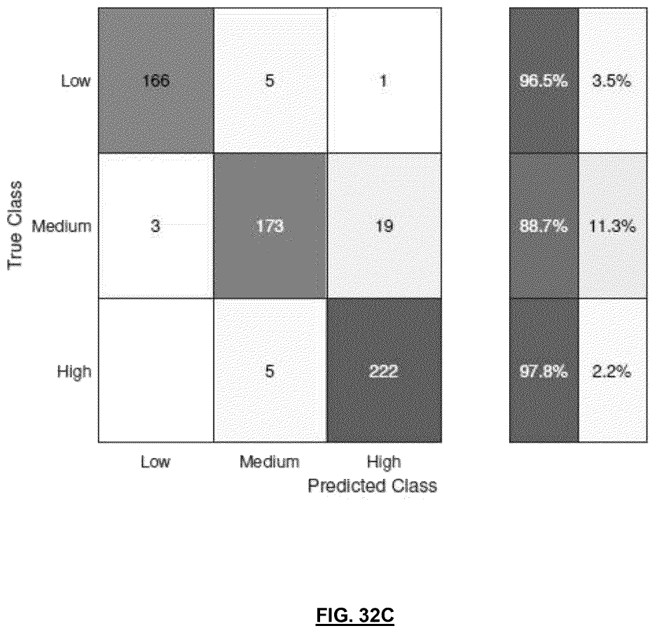

For testing, the optimization model-generated and RL-generated testing datasets are combined, and the classifiers' accuracies in distinguishing events are evaluated with respect to this combined dataset. Confusion matrices illustrating performances of Classifier-1 and Classifier-2 are depicted in FIGS. 32A and 32B, respectively. As expected, the noted shortcomings in data generated by each approach result in low performance. Training the same CNN classifier on the combined training and validation datasets mitigates these shortcomings, yielding a high-accuracy classifier as depicted in FIG. 32C. This result underscores the benefit of considering multiple methods for synthetic attack generation for defense and demonstrates the complementary advantages of both optimization and RL in terms of generating data. The classifier can be used to categorically assess, in real-time, the expected risks concerning frequency fluctuations that are associated with load changes in the power system.

The example experiments illustrate that the trained RL agent can be used as a real-time risk measure; enabling the derivation of a dynamic risk metric based on the agent's Q-value. The Q-value represents the cumulative reward anticipated by the agent from its current state. Consequently, the Q-value-based risk metric uses a specific formulation of the reward function. Given an example reward function, when the system is at some initial state [symbol] (denoted as [symbol] ₒ) with no action ( [symbol] =0), the RL agent recognizes the potential for substantial reward accumulation by attacking the power system. In each time-step, it receives a small reward until it forces the RoCoF to exceed its threshold, at which it earns a high reward. As the RL agent acts to earn these rewards, the power system becomes more susceptible to false triggering of RoCoF protection. Consequently, the Q-value generally decreases, reflecting the shorter time to failure and the fewer time-steps left to collect the small rewards. Hence, it can be surmised that training the RL agent to induce power system failure results in a critic that can effectively assess the real-time vulnerability of the system to attacks.

The risk metric, calculated as a function of the RL agent's Q-value, can be expressed by:

$$‖ \frac{1}{{max}_{𝒜} Q ( 𝒮 ; 𝒜 )} - \frac{1}{Q ( {𝒮}_{o} ; 0 )} ‖ \qquad ( 27 )$$

The first term predominantly quantifies the risk by determining how much harm an attack could potentially inflict on the power system given its current operating state, if an attacker (in this case, the RL agent) were to apply their best attack action. This best attack action is represented by taking the maximum of the Q-value over all actions. A higher value of this term indicates greater system vulnerability to attacks. The second term serves as a bias term, bringing the risk metric to zero at some nominal state [symbol] ₒ with zero actions. Equation (27) relies solely on frequency measurements of the system areas; the state [symbol] includes the frequency and RoCoF, with the latter derivable from the frequency measurements.

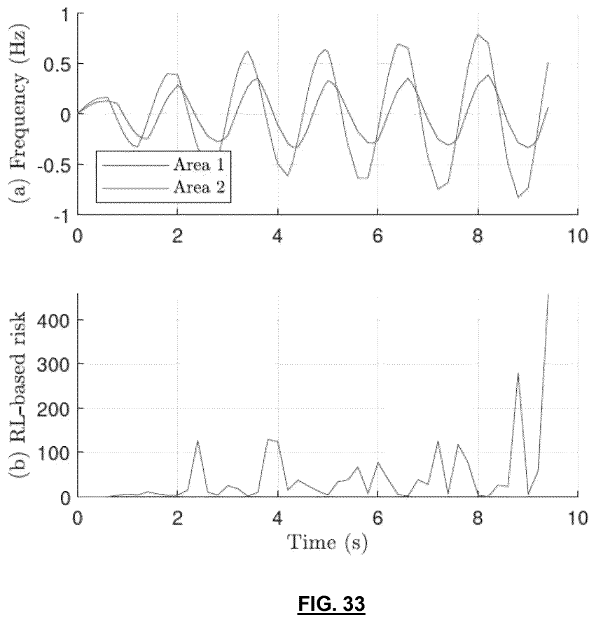

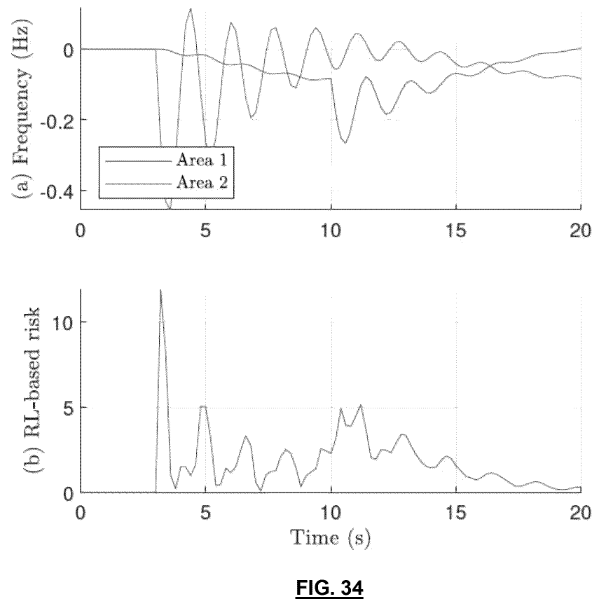

As an example, FIG. 33 presents the system frequencies during an RL-generated attack. The chart is used to evaluate the RL Q-value-based risk metric on a strategic malicious attack. For comparison, FIG. 34 shows the frequency during sudden, relatively large load changes: specifically, a 10% load increase in MG1 at 3 seconds, followed by a 5% load increase in MG2 at 10 seconds. The chart is used to evaluate the RL Q-value-based risk metric on a safe system disturbance. FIG. 34 demonstrates an increase in the risk metric during the load changes, although not reaching the elevated levels observed in the strategic attack launched by the RL agent. FIG. 33 reveals that the risk metric attains significantly high values well before system failure, escalating to a significantly high peak at failure. Advantageously, the example experiments illustrate how the above can be used for real-time grid monitoring systems, providing system operators with a dynamic assessment of a power system's vulnerability to unforeseen events or malicious cyberattacks for enhanced system defense.

The example experiments illustrate that the system 50 is able to advantageously perform systematic anomalous event synthesis for enhancing defense, including the ability to proactively discover intelligent attack strategies that sophisticated adversaries may employ to exploit system vulnerabilities and induce failures in ICS; enhance defense precision by effectively distinguishing between grid events, including malicious attacks, based on impact severity; provide proactive attack detection to prevent future system failures; and supply real-time risk metrics to assist system operators in comprehending system vulnerability.

Although the invention has been described with reference to certain specific embodiments, various modifications thereof will be apparent to those skilled in the art without departing from the spirit and scope of the invention as outlined in the claims appended hereto.

1. A method for determining actions that disrupt or compromise an industrial system for determination of vulnerabilities in the industrial system, the method executed on one or more processors, the method comprising:
receiving a dynamical model of operation of the industrial system;
iteratively training one or more reinforcement learning agents to each determine a learned policy that outputs one or more actions that disrupt or compromise the operation of the industrial system when applied to the dynamical model, the dynamical model takes as input the actions and outputs a representation of the response of the industrial system to such actions, training of each of the one or more reinforcement learning agents comprises learning the learned policy based on observing an operational state of the industrial system while sequences of the actions are injected into the dynamical model to determine the actions that force the industrial system into an unfavorable mode of operation or breach the safety of the industrial system by forcing its operational state outside a safe set of operation; and
outputting the one or more trained reinforcement learning agents or the one or more learned policies, or both, for determination of actions that disrupt or compromise the industrial system.

2. The method of claim 1, further comprising synthesizing failure scenarios of the industrial system using the one or more actions that disrupt or compromise the operation of the industrial system determined during training of the one or more reinforcement learning agents, and outputting the synthesized failure scenarios of the industrial system.

3. The method of claim 1, wherein the dynamical model comprises simulation testbeds, digital twins, or state-space dynamical models, and wherein one or more inputs to the industrial system permit the one or more reinforcement learning agents to inject disturbances that compromise or disrupt the operation of the industrial system.

4. The method of claim 1, wherein the industrial system comprises a power system, wherein the dynamical model comprises a model of operation of the power system, wherein the one or more actions that disrupt or compromise the operational aspect of the industrial system comprise disturbances that compromise the power system control or operation, or both.

5. The method of claim 1, wherein the actions cause changes in dynamics of the industrial system to place the industrial system in an undesirable or unsafe operation.

6. The method of claim 1, wherein training of the one or more reinforcement learning agents comprises using deep deterministic policy gradient reinforcement learning to simulate switching an entire load on or off.

7. The method of claim 1, wherein the one or more reinforcement learning agents are initialized without knowledge of the physical dynamics or characteristics of the industrial system.

8. The method of claim 1, wherein the iterations continue until a policy includes actions that provide the most detriment to the industrial system is reached.

9. The method of claim 1, wherein during each iteration of training, each reinforcement learning agent executes a sequence of the actions on the industrial system over a training episode, and wherein the actions are evaluated based on the extent to which the industrial system is driven into the unfavorable mode of operation.

10. The method of claim 1, further comprising using the learned policy to train a supervised machine learning model to categorize patterns of anomalies in the operational data of the industrial system, the supervised machine learning model taking operational data measurements of the industrial system as input.

11. A system for determining actions that disrupt or compromise an industrial system for determination of vulnerabilities in the industrial system, the system comprising one or more processors and a data storage, the data storage comprising instructions for the one or more processors to execute:
a data module to receive a dynamical model of operation of the industrial system; and
a machine learning module to:
train one or more reinforcement learning agents to each determine a learned policy that outputs one or more actions that disrupt or compromise the operation of the industrial system when applied to the dynamical model, the dynamical model takes as input the actions and outputs a representation of the response of the industrial system to such actions, training of each of the one or more reinforcement learning agents comprises learning the learned policy based on observing an operational state of the industrial system while sequences of the actions are injected into the dynamical model to determine the actions that force the industrial system into an unfavorable mode of operation or breach the safety of the industrial system by forcing its operational state outside a safe set of operation; and
output the one or more trained reinforcement learning agents or the learned policies, or both, for determination of actions that disrupt or compromise the industrial system.

12. The system of claim 11, wherein the machine learning module further synthesizes failure scenarios of the industrial system using the one or more actions that disrupt or compromise the operation of the industrial system determined during training of the one or more reinforcement learning agents, and outputting the synthesized failure scenarios of the industrial system.

13. The system of claim 11, wherein the industrial system comprises a power system, wherein the dynamical model comprises a model of operation of the power system, wherein the one or more actions that disrupt or compromise the operational aspect of the industrial system comprise disturbances that compromise the power system control or operation, or both.

14. The system of claim 11, wherein the actions cause changes in dynamics of the industrial system to place the industrial system in an undesirable or unsafe operation.

15. The system of claim 11, wherein during each iteration of training, each reinforcement learning agent executes a sequence of the actions on the industrial system over a training episode, and wherein the actions are evaluated based on the extent to which the industrial system is driven into the unfavorable mode of operation.

16. The system of claim 11, wherein the machine learning module further uses the learned policy to train a supervised machine learning model to categorize patterns of anomalies in the operational data of the industrial system, the supervised machine learning model taking operational data measurements of the industrial system as input.

17. A method for detecting anomalies in an industrial system, the method executed on one or more processors, the method comprising:
receiving a training dataset, the training dataset comprising control signal and sensor measurement data from a plurality of simulations on the industrial system;
training an autoencoder using the training dataset, the autoencoder comprising a neural network machine learning model, the autoencoder expressed as a mapping between the input data and a reconstruction of the input data, the training of the autoencoder comprising minimizing a mean square error between training data in the training dataset and reconstructions of such training data;
determining a threshold, using the autoencoder, to differentiate between normal and anomalous data based on a maximum reconstruction error; and
outputting the threshold for detection of anomalies in the industrial system.

18. The method of claim 17, further comprising:
receiving control signal and sensor measurement input data for the industrial system;
determining, using the trained autoencoder, whether reconstruction error for the input data is below the threshold;
labelling the input data as normal where the reconstruction error is below the threshold, and otherwise, labelling the input data as anomalous; and
outputting the labelling.

19. The method of claim 17, further comprising preparing the training dataset by performing a simulation of normal industrial system operation and randomly cropping portions of the training dataset.

20. The method of claim 19, wherein the portions are sampled at regular intervals and have variable time lengths.
